(19) United States
(12) Patent Application Publication
(10) Pub. No.: US 2024/0391802 A1
(43) Pub. Date: Nov. 28, 2024

(54) CATALYST FOR CO-GENERATION OF DESALINATED WATER AND ELECTRICITY

(71) Applicant: TECHNION RESEARCH AND DEVELOPMENT FOUNDATION LIMITED, Haifa (IL)

(72) Inventors: Matthew E. Suss, Haifa (IL); Arunchander Asokan, Haifa (IL); Shada Abu Khalla, Haifa (IL)

(21) Appl. No.: 18/695,811

(22) PCT Filed: Sep. 28, 2022
(86) PCT No.: PCT/IL2022/051030

§ 371 Date: Mar. 26, 2024

Related U.S. Application Data
(60) Provisional application No. 63/250,255, filed on Sep. 30, 2021.

(51) Int. Cl. C02F 1/46; C02F 1/461; C02F 103/08

(52) U.S. Cl. CPC C02F 1/4604; C02F 2001/46142; C02F 2103/08; C02F 2201/46115; C02F 2201/46145; C02F 2303/10

(57) ABSTRACT

The present invention provides a non-biological deionization fuel cell (DFC) comprising, inter alia, a cathode comprising a non-platinum group metal and a nitrogen doped carbon matrix. Further provided is a method of preparing the catalyst through a zeolitic imidazolate framework precursor.

### FIELD OF THE INVENTION

The present invention is directed to non-platinum group metal catalysts for use in desalination fuel cells and methods for the preparation thereof.

### BACKGROUND OF THE INVENTION

In recent years the demand for freshwater is escalated due to its increased consumption worldwide. Various technologies for water treatment have been developed to satisfy the global freshwater shortage including reverse osmosis, electrodialysis, capacitive deionization and desalination redox flow batteries. Nevertheless, these technologies consume enormous amounts of external electrical energy to desalinate water, typically supplied from fossil fuel sources.

A recently developed technology, termed the desalination fuel cell (DFC), obviates the need for fossil fuel sources. It involves the simultaneous desalination of feedwater and green electricity generation. The working principle of a DFC is based on separating the anode and cathode compartments of a fuel cell by at least two ion-exchange membranes between which feedwater is flown. An anode reactant participates in an oxidation reaction in the anode compartment and a cathode reactant participates in a reduction reaction in the cathode compartment, thereby producing positive and negative charge concentrations, respectively, that provide a driving force for anions and cations of the feedwater to pass through the exchange membranes to reduce the concentration of total dissolved solids in the feedwater.

WO 2020/129060 to some of the inventors of the present invention is directed to a method of deionization of a liquid including passing feedwater to be deionized through a deionization fuel cell system, which includes a deionization fuel cell, containing, inter alia, a cation exchange membrane and an anion exchange membrane and discharging said cell to produce electricity and deionized liquid, wherein the method does not include a step of charging the fuel cell prior to or following the discharge step.

WO 2016/120717 describes a desalinization device comprising a gas diffusion anode suitable to transform hydrogen into hydrogen ions; a gas diffusion cathode suitable to transform oxygen into hydroxide ions; a system to feed said gas diffusion anode with hydrogen; a system to feed said gas diffusion cathode with oxygen; a cation exchange membrane; and an anion exchange membrane.

WO 2013/016708 teaches that water can be desalinated in a process that can proceed in a thermodynamically favorable manner based on oxidation and reduction reactions occurring respectively at an anode and a cathode of an electrochemical desalination cell. Such a cell can include an anion exchange membrane, a cation exchange membrane, an anode assembly, a cathode assembly, and an external circuit connecting the anode assembly to the cathode assembly.

Various anode and cathode reagent pairs can be used in DFCs, including, inter-alia, hydrogen and oxygen. Hydrogen-oxygen DFC comprises three compartments, i.e., anode, desalination and cathode, wherein the anode and cathode compartments comprise catalyst-coated electrodes and, an anolyte and catholyte, respectively. When the device is supplied with H₂ and O₂, salty feedwater is pumped through the desalination compartment where salt ions are removed via spontaneously arising ionic current.

Efficiency of fuel cells, which involve the use of oxygen or air, is adversely affected by the sluggish cathodic oxygen reduction reaction (ORR), being the bottleneck of the overall redox reaction and which therefore requires highly efficient electroactive material. In addition to slower ORR kinetics, the anions such as bisulphate (HSO₄⁻), hydroxyl (OH⁻), and halides (X⁻) in the supporting electrolyte tend to adsorb on the catalyst surface and significantly block the active sites for the adsorption of the reactants and the active intermediates (M. Arenz, T. J. Schmidt, K. Wandelt, P. N. Ross, N. M. Markovic, J. Phys. Chem. B, 2003, 107, 9813-9819; K. Holst-Olesen, M. Reda, H. A. Hansen, T. Vegge, M. Arenz, ACS Catal., 2018, 8, 7104; P. W. Faguy, N. Markovic, R. R. Adzic, C. A. Fierro, E. B. Yeager, J. Electroanal. Chem. Interfacial Electrochem., 1990, 289, 245; N. M. Markovic, H. A. Gasteiger, P. N. Ross, J. Phys. Chem., 1995, 99, 3411). As a result, ORR suffers from large overpotential and undergoes unfavorable indirect pathway.

To date, platinum (Pt) deposited on high surface carbon powder (Pt/C) is considered as the benchmark catalyst for ORR. However, in addition to the general scarcity and high cost, in DFCs in particular, Pt-catalyzed ORR is significantly influenced by feedwater anions, specifically Cl⁻. Said Cl⁻ ions block the catalytic sites by forming Pt-Cl bonds followed by dissolution/re-deposition of metal nanoparticles on the electrode, thereby significantly inhibiting ORR kinetics (K. Mamtani, D. Jain, A. C. Co, U. S. Ozkan, Catal Lett., 2017, 147, 2903).

Currently, M-N—C based catalysts (wherein M is a non-platinum group metal (non-PGM), N is nitrogen, and C is carbon) are being explored for their unique electron structure which enables ORR catalysis with enhanced kinetics comparable to the state-of-the-art Pt/C catalyst. For example, cathode catalysts for a hydrogen-oxygen fuel cell with proton-conducting (acidic) and anion-conducting (alkaline) electrolytes synthesized via pyrolysis of nitrogen-containing iron and cobalt complexes on the surfaces of highly disperse carbon materials were shown to approach 60% Pt/C commercial platinum catalyst according to their activity in the oxygen reduction reaction in alkaline medium (O. V. Korchagin, V. A. Bogdanovskaya, M. R. Tarasevich, Catal. Ind., 2016, 8, 265). Fe—N—C catalysts were also reported to have respectable ORR activity in rotating disk electrode (RDE) testing with a half-wave potential (Eu₂) of 0.88±0.01 V vs. the reversible hydrogen electrode (RHE) in acidic medium, i.e., 0.5 M H₂SO₄ electrolyte (H. Zhang, H. T. Chung, D. A. Cullen, S. Wagner, U. I. Kramm, K. L. More, P. Zelenay, G. Wu, Energy Environ. Sci., 2019, 12, 2548). In another study, the best-performing catalyst in both alkaline and acidic medium was found to be C—Fe(OH)₃@ZIF-1000, which features a hollow polyhedron (interior cavity: ca. 48 nm) with a thin carbon shell (ca. 5 nm), exhibiting a high Brunauer-Emmet-Teller (BET) surface area of 1021 m² g⁻¹(J. W. Huang, Q. Q. Cheng, Y. C. Huang, H. C. Yao, H. B. Zhu, H. Yang, ACS Applied Energy Materials, 2019, 2(5), 3194).

M-N—C catalysts have also been recently used in microbial fuel cells (MFC). U.S. 2017/0092959 describes non-PGM catalysts having a morphology that makes them particularly suitable for use in a cathode of a microbial fuel cell, and in particular, an oxygen reduction reaction (ORR) catalyst, wherein the ORR catalyst is a metal-nitrogen-carbon catalyst. The anode typically includes a structure that has been colonized with bacteria that are able to oxidize oxidizeable compounds in liquid, such as carbon-containing contaminants found in wastewater in order to produce CO₂, electrons and protons.

Iron-nitrogen-carbon-based catalysts were also employed in microbial desalination cells (MDC), wherein the Fe—N—C catalyst was prepared by using nicarbazin (NCB) as the organic precursor through a sacrificial support method (C. Santoro, M. R. Talarposhti, M. Kodali, R. Gokhale, A. Serov, I. Merino-Jimenez, I. Ieropoulos, P. Atanassov, ChemElectroChem, 2017, 4, 3322). The use of non-PGM catalysts in MFC and MDC is mostly dictated by the need to reduce the overall cost of said systems. While MFC cathodes also suffer from cathode poisoning under operating conditions, the poisoning species are mostly nitrate, sulfides, and sulfates (Y. H. Jia, H. T. Tran, D. H. Kim, S. J. Oh, D. H. Park, R. H. Zhang, D. H. Ahn, Bioprocess Biosyst. Eng., 2008, 31, 315; C. Santoro, A. Serov, C. W. Narvaez Villarrubia, S. Stariha, S. Babanova, K. Artyushkova, A. J. Schuler, P. Atanassov, Scientific Reports, 2015, 5, 16596; K. Liew, W. R. W. Daud, M. Ghasemi. J. X. Leong, S. S. Lim, M. Ismail, Inter. J. Hydrogen Energy, 2014, 39, 4870; T. Odedairo, X. Yan, J. Ma, Y. Jiao, X. Yao, A. Du, Z. Zhu, ACS Appl. Mater. Interfaces, 2015, 7, 21373; X. X. Ma, X. Q. He, T. Asefa, Electrochim. Acta, 2017, 257, 40) which interfere with the electrochemical reduction process at a cathode leading to several by-products and resulting in mixed potential. In some MFCs, chlorides can also interfere with the ORR to a certain degree, however, the concentration of chlorides at a cathode compartment is significantly lower when compared to other anions. In MDC, the environment in the electrode compartment is tailored to keep the microbes alive, such that the solution near the cathode is not rich in chloride and the MDC cathode does not suffer from halide poisoning.

There exists, therefore, an unmet need for low-cost electrocatalysts having improved ORR kinetics and long-term stability, which would be suitable for use specifically in the strong chloride anion-adsorbent environment of DFCs.

### SUMMARY OF THE INVENTION

The present invention provides a non-biological deionization fuel cell containing a cathode which comprises a non-platinum group metal and a nitrogen doped carbon matrix. In some embodiments, the cathode comprises a non-platinum group metal and a boron and nitrogen co-doped carbon matrix. The catalyst disclosed herein is configured to catalyze an oxygen reduction reaction (ORR) taking place at the cathode which is exposed to high concentrations of chloride anions. The present invention further provides a method of preparing the catalyst which involves a high temperature pyrolysis of a precursor comprising a zeolitic imidazolate framework (ZIF) and metal ions.

The present invention is based, in part, on a surprising finding that a Fe—N—C catalyst and a Co/B—C—N catalyst can be utilized in a cathode of a DFC for effective desalination and power output under ambient operating conditions. In particular, when tested in a DFC, the catalysts of the present invention showed higher OCV as compared to a commercial Pt/C catalyst, exhibiting better ORR kinetics. Being significantly more cost-effective, the catalysts were found to be comparable with the more expensive Pt/C in terms of voltage efficiency per the cost of 1 gr of catalyst. Furthermore, the catalysts showed higher stability in long-term DFC operation than the Pt/C catalyst. Importantly, while the ORR activity of the Pt/C catalyst was impaired due to Pt surface poisoning by chloride ions, the catalysts of the present invention showed excellent chloride tolerance. Overall, these results show that non-platinum group metal catalysts maintain or improve cell performance while significantly reducing cell costs and can therefore be used as alternatives to platinum-based catalysts.

In one aspect, there is provided a deionization fuel cell (DFC) comprising: a cathode; an anode; a catholyte flow channel; an anolyte flow channel, and at least: a cation exchange membrane (CEM); an anion exchange membrane (AEM), and a feedwater flow channel, wherein: the catholyte flow channel is disposed adjacent to the cathode, the anolyte flow channel is disposed adjacent to the anode, and the feedwater flow channel is formed between the CEM and the AEM and is configured for the deionization of feedwater; wherein the feedwater contains at least about 10 mM of chloride ions (Cl⁻), wherein the cathode comprises a catalyst comprising a non-platinum group metal and a nitrogen doped carbon matrix, wherein the catalyst is configured to catalyze an oxygen reduction reaction (ORR) taking place at the cathode, and wherein the DFC is a non-biological DFC.

In one embodiment, the catalyst comprises a non-platinum group transition metal. In another embodiment, the non-platinum group transition metal comprises at least one of Fe, Co, Mn, Zn, Ce, Cr, Cu, Mo, Ni, Ta, Ti, V, W, and Zr. Each possibility represents a separate embodiment. In some exemplary embodiments, the metal is iron (Fe) and the catalyst is a Fe—N—C catalyst. In other exemplary embodiments, the metal is cobalt (Co).

In certain embodiments, the carbon is further doped by boron. In particular embodiments, the catalyst is a Co/B—C—N catalyst.

In various embodiments, the catalyst comprises metal nanoparticles having a mean particle size of above 8 nm. In other embodiments, the catalyst comprises metal nanoparticles having a mean particle size of about 10 nm to about 40 nm, including each value within the specified range.

In further embodiments, the catalyst comprises metal particles which are atomically dispersed in the carbon matrix.

In other embodiments, the carbon matrix comprises a graphitic carbon lattice. In yet other embodiments, the graphitic carbon lattice is characterized by a degree of disorder ranging from 0.8 to 1.10, including each value within the specified range. In particular embodiments, the graphitic carbon lattice is characterized by a degree of disorder ranging from 0.8 to 1.11, including each value within the specified range. In further embodiments, the catalyst has a mean pore size of about 3 nm to about 10 nm, including each value within the specified range. In specific embodiments, the catalyst has a mean pore size of above 3.8 nm to below 8 nm, including each value within the specified range. In additional specific embodiments, the catalyst has a mean pore size of about 4 nm to about 5 nm, including each value within the specified range.

In some embodiments, the catalyst comprises a nitrogen content of less than about 2% at. In additional embodiments, the nitrogen content in the catalyst ranges between about 0.7% at. and about 1% at., including each value within the specified range.

In further embodiments, when doped with boron, the boron content in the catalyst ranges between about 0.01% at. and about 1% at., including each value within the specified range. In certain embodiments, when doped with boron, the boron content in the catalyst ranges between about 0.1% at. and about 1% at., including each value within the specified range. In particular embodiments, when doped with boron, the boron content in the catalyst ranges between about 0.1% at. and about 0.5% at., including each value within the specified range.

In some embodiments, the feedwater contains at least about 20 mM of chloride ions (Cl⁻). In other embodiments, the feedwater contains at least about 50 mM of chloride ions (Cl⁻). According to yet other embodiments, the feedwater contains at least about 100 mM of chloride ions (Cl⁻). According to further embodiments, the feedwater contains between about 10 mM and about 500 mM of chloride ions (Cl⁻), including each value within the specified range. According to additional embodiments, the feedwater contains between about 10 mM and about 200 mM of chloride ions (Cl⁻), including each value within the specified range.

In various embodiments, the feedwater is selected from the group consisting of seawater, brackish water, hard water, wastewater and organic streams needing remediation. Each possibility represents a separate embodiment.

In further embodiments, the CEM and/or AEM is independently at each occurrence, selected from the group consisting of an ion-selective polymeric membrane, an ion-selective ceramic separator, an ion-selective zeolite separator, and an ion-selective glass separator. Each possibility represents a separate embodiment.

In additional embodiments, the AEM is selected from the group consisting of non-alkaline anion exchange membrane, alkaline anion exchange membrane (AAEM), hydroxide-exchange membrane (HEM), anion-exchange ionomer membrane (AEI), and combinations thereof. Each possibility represents a separate embodiment. In other embodiments, the CEM is selected from the group consisting of non-acidic cation exchange membrane, proton-exchange membrane (PEM), cation-exchange ionomer membrane, and combinations thereof. Each possibility represents a separate embodiment.

In some embodiments, the anolyte flow channel comprises a reductant and/or its oxidation reaction product. In specific embodiments, the reductant comprises hydrogen gas (H₂). In other specific embodiments, the reductant comprises a combination of hydrogen gas (H₂) and hydroxyl ions (OH⁻).

In other embodiments, the catholyte flow channel comprises an oxidant and/or its reduction reaction product. In particular embodiments, the oxidant comprises oxygen gas (O₂). In other particular embodiments, the oxidant comprises a combination of oxygen gas (O₂) and protons (H⁺).

In some embodiments, the DFC further comprises at least one additional CEM and a feedwater flow, wherein the anolyte flow channel is formed between the additional CEM and the anode; and the additional feedwater flow channel is formed between the AEM and the additional CEM. In other embodiments, the DFC further comprises at least one additional CEM, AEM, and a feedwater flow, wherein the catholyte flow channel is formed between the cathode and the additional AEM; the anolyte flow channel is formed between the additional CEM and the anode; one additional feedwater flow channel is formed between the AEM and the additional CEM; and another additional feedwater flow channel is formed between the CEM and the additional AEM.

In another aspect, there is provided a method of preparing a chloride-tolerant catalyst comprising a non-platinum group metal and a nitrogen doped carbon matrix, the method comprising: (a) providing a precursor comprising a zeolitic imidazolate framework (ZIF) and non-platinum group metal ions; and (b) pyrolyzing the precursor of step (a) at a temperature ranging from above 800° C. to below 1,100° C., including each value within the specified range.

According to some embodiments, the pyrolysis is performed at a temperature of about 900° C. According to other embodiments, the pyrolysis is performed at a temperature of about 1,000° C. In further embodiments, the ZIF is a B-doped ZIF.

In further embodiments, there is provided a chloride-tolerant catalyst comprising a non-platinum group metal and a nitrogen doped carbon matrix prepared according to the method described hereinabove. In additional embodiments, there is provided a chloride-tolerant catalyst comprising Fe and a nitrogen doped carbon matrix prepared according to the method described hereinabove. In yet other embodiments, there is provided a chloride-tolerant catalyst comprising Co and a boron and nitrogen co-doped carbon matrix prepared according to the method described hereinabove. The catalysts prepared according to the method described herein can be incorporated into deionization fuel cell.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1. Pictorial representation of the DFC and the synthesis procedure of Fe/N/C catalysts according to certain embodiments of the present invention.

FIG. 2. Comparative CVs of Pt/C with and without Cl⁻ ions recorded in N₂ saturated electrolyte, 0.1 M aqueous HClO₄ with a scan rate of 50 mV s⁻¹.

FIGS. 3A-3H. Scanning electron micrographs of (3A) Fe-ZIF-8, (3B) Fe/N/C-900 pyrolyzed at 900° C. (inset: corresponding image recorded using energy selective backscattered (ESB) electrons), (3C) Fe/N/C-900 pyrolyzed at 900° C. followed by acid leaching (inset: corresponding image recorded using ESB electrons), and (3D-3H) STEM elemental mapping of the Fe/N/C-900 catalyst, (3D): all elements, (3E): C, (3F): O, (3G): N, and (3H): Fe.

FIGS. 4A-4F. Transmission electron micrographs of Fe/N/C catalysts pyrolyzed at (4A) 800° C., (4B) 900° C., and (4C) 1000° C. (4D), (4E) and (4F) show particle size distributions of Fe/N/C catalysts pyrolyzed at 800, 900, and 1000° C., respectively.

FIG. 5. Comparative Raman spectra of Fe/N/C-800, Fe/N/C-900, and Fe/N/C-1000 catalysts.

FIG. 6. Comparative XRD patterns of Fe/N/C-800, Fe/N/C-900, and Fe/N/C-1000 catalysts.

FIGS. 7A-7B. (7A) CVs of Fe/N/C-800, Fe/N/C-900, and Fe/N/C-1000 catalysts recorded in 0.1 M aqueous HClO₄ electrolyte (dotted: in N₂ and solid: in O₂ saturated electrolytes) with a scan rate of 50 mV s⁻¹. (7B) Corresponding LSVs recorded in O₂ saturated 0.1 M aqueous HClO₄ electrolyte at a scan rate of 5 mV s⁻¹ with different rotational rates.

FIGS. 8A-8D. Comparative XPS (8A) survey spectra and high resolution, deconvoluted (8B) C1s, (8C) O1s, and (8D) N1s spectra of Fe/N/C-800, Fe/N/C-900, and Fe/N/C-1000 catalysts.

FIG. 9. High resolution XPS Fe2p spectra of Fe/N/C-800, Fe/N/C-900, and Fe/N/C-1000 catalysts.

FIG. 10. Comparative LSVs of Fe/N/C-900 catalyst synthesized with different Fe concentrations (2.5 mM, 5 mM, and 7.5 mM) and a control material without Fe (N/C).

FIGS. 11A-11F. (11A, 11C, and 11E) N₂-sorption isotherms for Fe/N/C-900 catalysts synthesized with different Fe concentrations. (11B, 11D, and 11F) Corresponding pore size distribution data.

FIGS. 12A-12F. (12A) Chronoamperometric response of Fe/N/C-900 and Pt/C catalysts recorded in O₂ saturated 0.1 M aqueous HClO₄ electrolyte for 50 h. (12B) LSVs and (12C) the corresponding diffusion-corrected Tafel plots of Fe/N/C-900 and Pt/C catalysts with and without Cl⁻ ions recorded with a scan rate of 5 mV s⁻¹ at 1,600 rpm. (12D) Disk and (12E) ring responses of Fe/N/C-900 (with different catalyst loadings viz. 200, 400, 600, 800, and 1,000 μg cm⁻²) and Pt/C catalysts. (12F) The corresponding electron transfer number and peroxide yield calculated from the RRDE measurements.

FIGS. 13A-13B. LSVs of (13A) Pt/C and (13B) Fe/N/C catalysts before and after continuous potential cycles recorded in 0.5 M aqueous NaCl electrolyte with a scan rate of 5 mV s⁻¹ at a rotational rate of 1,600 rpm.

FIG. 14. HOR LSVs of Pt/C recorded in H₂ saturated 0.1 M aqueous NaOH electrolyte with and without Cl-ions at a scan rate of 10 mV s⁻¹ and a rotational rate of 1,600 rpm.

FIGS. 15A-15C. (15A) Comparative polarization data of equilibrium voltage vs. current density for DFC containing Fe/N/C-900 and Pt/C cathode catalysts in H₂—O₂ feed at the anode and cathode, respectively, under ambient pressure and temperature. For anolyte and catholyte, 0.5 M NaCl/0.1 M NaOH and 0.5 M NaCl/0.1 M HCl, respectively, were used. (15B) Corresponding ionic conductivity data of the desalted stream vs. current density during DFC polarization measurement. (15C) DFCs stabilities for the cathodes containing Pt/C and Fe/N/C-900 at a constant voltage of 1 V for 8 h.

FIG. 16. A schematic representation of the synthesis procedure of atomically dispersed Co particles on B—N co-doped carbon according to certain embodiments of the present invention.

FIGS. 17A-17F. TEM images of (17A) B—N co-doped carbon and, (17B), (17C) and (17D) Co/B—C—N catalysts pyrolyzed at 900, 1,000, and 1,100° C., respectively. (17E) HRTEM and (17F) HAADF-STEM of Co/B—C—N synthesized at 1,000° C.

FIGS. 18A-18E. Comparative LSVs of (18A) different Co precursor concentrations (20 mM, 30 mM, and 40 mM) pyrolyzed at 900° C., (18C) different pyrolyzed temperatures (900, 1,000, and 1,100° C.) with a 30 mM Co precursor. Comparative chloride tolerance RRDE measurement data (18B) disk current, (18D) ring current, and (18E) the corresponding calculated number of electrons transfer and hydrogen peroxide data during ORR.

FIGS. 19A-19E. Comparative (19A) ring current and (19B) disk current for the different catalyst loadings recorded in O₂ saturated 0.1 M aqueous HClO₄ electrolyte. The corresponding calculated average (19C) number of electrons transferred and (19D) hydrogen peroxide yield during ORR. (19E) Comparative LSVs of Pt/C and Co/B—C—N-1000 catalysts before and after continuous potential cycles.

FIGS. 20A-20C. (20A) Comparative DFC polarization curves of Pt/C and Co/B—N—C-1000 cathode catalysts in H₂—O₂ feed under ambient pressure and temperature. (20B) Corresponding ionic concentration data of the desalted stream vs. current density, during DFC polarization measurements. (20C) Comparative stability data of DFCs at a constant 1.0 V maintained up to 24 h.

### DETAILED DESCRIPTION OF THE INVENTION

The present invention provides a catalyst comprising a non-platinum group metal and a nitrogen doped carbon matrix utilized as a cathode in a deionization fuel cell (DFC) system for the concurrent desalination of feedwater and generation of electricity.

The deionization fuel cell system of the present invention is based in part on a surprising finding that the catalyst, for example a Fe—N—C catalyst or a Co—B—C—N catalyst, is capable of providing comparable voltage efficiency of the DFC to that obtained by the state-of-the-art Pt/C electrode, when normalized to the catalyst cost. The catalysts disclosed herein for the first time are configured to catalyze the sluggish oxygen reduction reaction. While the ORR activity of the hitherto used Pt/C catalysts is known to be compromised by chloride ions which are typically present in brine, the catalysts of the present invention provide unexpected tolerance to chloride ions whereby the ORR activity is maintained.

Thus, according to certain aspects and embodiments, there is provided a deionization fuel cell (DFC) comprising: a cathode; an anode; a catholyte flow channel; an anolyte flow channel, and at least: a first cation exchange membrane (CEM); a first anion exchange membrane (AEM), and a first feedwater flow channel, wherein: the catholyte flow channel is disposed adjacent to the cathode, the anolyte flow channel is disposed adjacent to the anode, and the first feedwater flow channel is formed between the first CEM and the first AEM and is configured for the deionization of feedwater; wherein the feedwater contains at least about 10 mM of chloride (Cl⁻); wherein the cathode comprises a metal-nitrogen-carbon (M-N—C) catalyst, wherein the metal is a non-platinum group metal; wherein the M-N—C catalyst is configured to catalyze an oxygen reduction reaction (ORR) taking place at the cathode; and wherein the DFC is a non-biological DFC. In some currently preferred embodiments, the metal is iron and the catalyst is Fe—N—C. In other currently preferred embodiments, the metal is cobalt, the carbon is further doped by boron, and the catalyst is Co—B—C—N.

The terms “deionization” and “desalination” are used interchangeably and refer to the reduction in the total dissolved solids (TDS) content of the feedwater.

The term “fuel cell”, as used herein, refers in some embodiments to an electrochemical cell that converts chemical energy into electricity through an electrochemical reaction between redox active species, which include a reductant and an oxidant, wherein at least one of the reductant and the oxidant is stored outside the electrochemical cell. In some embodiments, the oxidant and/or the reductant is continuously supplied to the DFC during the electrochemical operation thereof.

The term “desalination fuel cell” or “DFC”, as used herein, refers to a fuel cell having a modified structure, including, inter alia, at least two ion exchange membranes and a feedwater flow channel therebetween, which provides deionization of feedwater supplied to the fuel cell, during electrochemical operation thereof.

The term “non-biological DFC” as used herein, refers to a DFC, which does not contain electro-active microorganisms which are configured to generate an electric current during electrochemical operation of the DFC.

In some embodiments, the oxidant is stored outside the DFC and is continuously supplied to the DFC during the electrochemical operation thereof. In some embodiments, the oxidant is freely supplied to the DFC from the surrounding atmosphere. In some embodiments, said oxidant is oxygen or air. In some embodiments, the reductant is stored outside the DFC and is continuously supplied to the DFC during the electrochemical operation thereof. The reductant can be selected from the group consisting of hydrogen, hydroxyl ion, sulfur, zinc, sodium, lithium, potassium, magnesium, calcium, aluminum, and iron. Each possibility represents a separate embodiment. In some embodiments, said reductant is hydrogen. In some currently preferred embodiments, hydrogen is used directly (i.e., without a separate conversion step), thereby providing directly hydrogen-driven DFC.

The term “electrochemical operation”, as used herein, refers in some embodiments, to the operation of the system or the DFC, wherein the voltage between the anode and the cathode in the DFC is different than the open circuit voltage (OCV). In particular embodiments, said electrochemical operation comprises discharging the DFC.

According to some embodiments, the cathode and the anode are connected via an external electric circuit. In further embodiments, said electric circuit comprises an electric load, wherein said load can be configured to draw electricity from the DFC. In some embodiments, the DFC is connected to an operating system through said electric circuit, which allows controlling the potential applied or established between the anode and the cathode or the electric current drawn from the DFC. For example, pumps, which flow the feedwater, anolyte, and/or catholyte through the DFC can draw electricity from said electric circuit. In certain such embodiments, the system is operated by electricity, which it produces.

The DFC according to the principles of the present invention is based on the oxygen reduction reaction, which takes place at the cathode.

The term “oxygen reduction reaction” or “ORR”, as used herein, refers to the half-reaction which results in the reduction of oxygen gas. Depending on the medium in which the reaction takes place, the reaction pathways and stoichiometries can differ. According to some embodiments, the ORR reaction takes place in an acidic medium.

According to the principles of the present invention, the cathode comprises a catalyst comprising a non-platinum group metal and a nitrogen doped carbon matrix. Suitable catalysts within the scope of the present invention include, but are not limited to, M-N—C catalysts and M-B—C—N catalysts wherein M is a non-platinum group metal.

The term “non-platinum group metal”, as used herein, refers to any metal other than a platinum-group (PG) metal.

The term “platinum-group metal”, as used herein, refers to six transition metals in the d-block (groups 8, 9, and 10, periods 5 and 6), said transition metals being ruthenium, rhodium, palladium, osmium, iridium, and platinum.

The term “catalyst”, as used herein, refers to a compound or composition, which catalyzes a desired reaction, including the type of electrocatalytic reactions required for use in various types of fuel cells, such as, e.g., ORR. The catalyst may include multiple types of materials, including, inter alia, catalytic materials and supporting materials (either active or inactive).

The term “catalytic material”, as used herein, is meant to encompass any material which contains an active site that enables catalysis, but which may or may not require the presence of a support when in use. Accordingly, a catalyst may be formed, for example, by applying a particulate catalytic material to a carbon support. The catalytic material can be further supported on a gas diffusion layer (GDL), which typically contains a carbon-based cloth or paper and can further contain a layer of carbon powder mixed with a binder.

According to various embodiments, the non-platinum group metal is a transition metal. Non-limiting examples of suitable transition metals include Fe, Co, Mn, Zn, Ce, Cr, Cu, Mo, Ni, Ta, Ti, V, W, and Zr. Each possibility represents a separate embodiment. In some exemplary embodiments, the metal is Fe. In certain such embodiments, the catalyst is referred to as Fe—N—C. In other embodiments, the metal is Co. In certain such embodiments, the catalyst which further comprises boron doping is referred to as Co—B—C—N.

According to some aspects and embodiments, the mean particle size of the metal particles is above 8 nm. In additional embodiments, the mean particle size of the metal particles ranges between about 16 nm and about 51 nm, including each value within the specified range. In some embodiments, the mean particle size of the metal particles ranges between about 10 nm and about 40 nm, including each value within the specified range. In certain embodiments, the mean particle size is about 16 nm. The mean particle size of the catalyst can be measured, for example, by Transmission Electron Microscopy (TEM) coupled with a suitable image processing software.

According to certain aspects and embodiments, the metal particles are atomically dispersed in the nitrogen doped or the boron and nitrogen co-doped carbon matrix.

According to further aspects and embodiments, the catalyst comprises a carbon matrix comprising a graphitic carbon lattice. In other embodiments, it has a degree of disorder below 1.12. According to some embodiments, the degree of disorder ranges between 0.75 and 1.11, for example between 0.75 and 1.10, including each value within the specified ranges. In further embodiments, the degree of disorder ranges between 0.8 and 1.10, including each value within the specified range. In certain embodiments, the degree of disorder is about 1.10. The terms “degree of disorder” and “ID/IG” as used herein refer to the ratio of the intensities of the D peak (ID) and the G peak (IG) of the catalyst, as measured by Raman spectroscopy, wherein D is the defect band (around 1330 cm⁻¹) and G is the optical phonon of carbon atoms moving in phase opposition (around 1580 cm⁻¹).

According to additional aspects and embodiments, the catalyst is characterized by a porous structure. Typically, it contains pores with an average size of about 3 nm to about 10 nm, including each value within the specified range. In certain embodiments, the average pore size is above 3.8 nm and below 8 nm, including each value therebetween. In particular embodiments, the catalyst has a mean pore size of about 4 nm to about 5 nm, including each value within the specified range. The average pore volume/size can be measured as is known in the art, for example using gas adsorption and desorption isotherms.

According to some aspects and embodiments, the catalyst has a nitrogen content of less than about 2% at. In some embodiments, the nitrogen content ranges between about 0.7% at. and about 1% at., including each value within the specified range. In some embodiments, the nitrogen content ranges between about 0.67% at. and about 0.75% at., including each value within the specified range. The nitrogen content of the catalyst can be measured by any suitable elemental analyzer device or software.

According to some aspects and embodiments, when doped with boron, the catalyst has a boron content of about 0.01% at. to about 1% at., including each value within the specified range. In certain embodiments, when doped with boron, the catalyst has a boron content of about 0.1% at. to about 1% at., including each value within the specified range. In particular embodiments, when doped with boron, the catalyst has a boron content of about 0.1% at. to about 0.5% at., including each value within the specified range. In currently preferred embodiments, when doped with boron, the catalyst has a boron content of about 0.3% at. The boron content of the catalyst can be measured by any suitable elemental analyzer device or software, e.g., XPS.

The anode can comprise carbon, e.g., a carbon cloth, which serves as a gas diffusion layer. The anode can further contain a catalytic layer disposed on the gas diffusion layer. In some embodiments, the catalytic layer comprises a noble metal, such as Pt or its alloy. The noble metal can be in a form of a metal powder or, alternatively, can be supported on a high surface area carbon powder.

The anode and/or the cathode suitable for use in the DFC can be in a form of a planar solid electrode. The planar solid electrode can be of any type suitable for use in a fuel cell, including, but not limited to, a plate, a sheet, a foil, a film, a cloth, a paper, a mesh or a felt. Each possibility represents a separate embodiment. The thickness of the planar solid electrode can range from about 0.01 mm to about 10 mm, including each value within the specified range.

According to the principles of the present invention, the DFC includes at least one AEM. AEMs can be described as polymer electrolytes that conduct anions, such as, for example, Cl-, as they contain positively charged (cationic) groups, typically covalently bound to a polymer backbone. These cationic functional groups can be bound either via extended side chains (alkyl or aromatic types of varying lengths) or directly onto the backbone (often via CH₂ bridges); or can be an integral part of the backbone. Non-limiting examples of suitable AEM types include non-alkaline anion exchange membrane, alkaline anion exchange membrane (AAEM), hydroxide-exchange membrane (HEM), anion-exchange ionomer membrane (AEI), and combinations thereof. Each possibility represents a separate embodiment. The polymer backbones suitable for use in the AEM include, inter alia, poly(arylene ethers) of various chemistries, such as polysulfones (including cardo, phthalazinone, fluorenyl, and organic-inorganic hybrid types), poly(ether ketones), poly(ether imides), poly(ether oxadiazoles), and poly(phenylene oxides) (PPO); polyphenylenes, perfluorinated types, polybenzimidazole (PBI) types including where the cationic groups are an intrinsic part of the polymer backbones, poly(epichlorohydrins) (PECH), unsaturated polypropylene and polyethylene types, including those formed using ring opening metathesis polymerization (ROMP), those based on polystyrene, poly(styrene/divinyl benzene) (PS/DVB), and poly(vinylbenzyl chloride), polyphosphazenes, radiation-grafted types, those synthesized using plasma techniques, pore-filled types, electrospun fiber types, PTFE-reinforced types, and those based on poly(vinyl alcohol) (PVA). Each possibility represents a separate embodiment. Non-limiting examples of suitable cationic groups include amines, quaternary ammoniums (QA) such as, for example, benzyltrialkylammoniums; heterocyclic systems including imidazolium, benzimidazoliums, PBI systems where the positive charges are on the backbone (with or without positive charges on the side-chains), and pyridinium types; guanidinium systems (e.g., pentamethylguanidinium groups); P-based systems types including stabilized phosphoniums (e.g. tris(2,4,6-trimethoxyphenyl)phosphonium and P-N systems such as phosphatranium and tetrakis(dialkylamino)phosphonium systems; sulfonium types; and metal-based systems with the ability to have multiple positive charges per cationic group. Each possibility represents a separate embodiment.

According to the principles of the present invention, the DFC includes at least one CEM. CEMs can be described as polymer electrolytes that conduct cations, such as, for example, Na⁺, as they contain negatively charged (anionic) groups, typically covalently bound to a polymer backbone. Non-limiting examples of suitable CEM types include non-acidic cation exchange membrane, proton-exchange membrane (PEM), cation-exchange ionomer membrane, and combinations thereof. Each possibility represents a separate embodiment. The polymer backbones suitable for use in the CEM include, inter alia, sulfonate containing fluoropolymer, such as, for example, NAFION®; sulfonated poly(ether ether ketone); polysulfone; poly(styrene/divinyl benzene (PS/DVB); polyethylene; polypropylene; ethylene-propylene copolymer; polyimide; and polyvinyldifluoride. Each possibility represents a separate embodiment. Non-limiting examples of suitable anionic groups include sulfite, carboxy, and phosphite groups. Each possibility represents a separate embodiment. Additionally, lithium super ionic conductor (LISICON) membranes can be used.

The flow channel formed between the cathode and the first CEM is configured for the flow of a catholyte. The flow channel formed between the anode and the first AEM is configured for the flow of an anolyte.

The term “anolyte”, as used herein, refers to a fluid being in contact with the anode during the DFC electrochemical operation and comprising a reductant, a product of the oxidation reaction of the reductant, or both. The term “reductant”, as used herein, is meant to encompass a single reactant, which reacts at the anode by changing an oxidation state of at least one of its atoms, to produce the oxidation reaction product, as well as, a combination of two or more reactants, which react at the anode to produce the oxidation reaction product, which is a chemical compound held together by covalent bonds, wherein only one of the reactants changes its oxidation state and the oxidation state of the other reactants remain unchanged. For example, in a hydrogen-oxygen DFC, the reductant comprises a combination of hydrogen gas (H₂) and hydroxyl ions (OH⁻), which form water at the anode, wherein the oxidation state of hydrogen atoms in the hydrogen gas changes in the course of the oxidation reaction and the oxidation state of oxygen and hydrogen atoms of the hydroxyl ions remains unchanged.

The term “catholyte”, as used herein, refers to a fluid being in contact with the cathode during the DFC electrochemical operation and comprising an oxidant, a product of the reduction reaction of the oxidant, or both. The term “oxidant”, as used herein, is meant to encompass a single reactant, which reacts at the cathode by changing an oxidation state of at least one of its atoms, to produce the reduction reaction product, as well as, a combination of two or more reactants, which react at the cathode to produce the reduction reaction product, which is a chemical compound held together by covalent bonds, wherein only one of the reactants changes its oxidation state and the oxidation state of the other reactants remain unchanged. For example, in a hydrogen-oxygen DFC, the oxidant comprises a combination of oxygen gas (O₂) and protons (H⁺), which form water at the cathode, wherein the oxidation state of oxygen atoms in the oxygen gas change in the course of the reduction reaction and the oxidation state of hydrogen atoms of the protons remains unchanged. The term “product”, as used herein, is meant to encompass the final product of the reduction or oxidation reactions, as well as intermediate products and by-products of said reactions.

In some embodiments, the catholyte comprises a suitable electrolyte or solvent. The catholyte can further include the oxidant and the product of the oxidant reduction reaction. In certain embodiments, said oxidant and/or product of the reduction reaction is dissolved in the electrolyte or solvent. In some embodiments, the anolyte comprises a suitable electrolyte or solvent. The anolyte can further include the reductant and/or the product of the reductant oxidation reaction. In certain embodiments, said reductant and/or product of the oxidation reaction is dissolved in the electrolyte or solvent. The electrolyte or solvent can be aqueous or organic-based. Non-limiting examples of aqueous-based solvents include water; acidic solution, such as, hydrochloric acid, sulfuric acid, hydrobromic acid, or trifluoromethanesulfonic acid (TFMS); and alkaline solution, such as, sodium hydroxide, potassium hydroxide, lithium hydroxide, or ammonium hydroxide. Each possibility represents a separate embodiment. Non-limiting examples of suitable organic solvents include propylene carbonate and ethylene glycol. Each possibility represents a separate embodiment. The anolyte and/or catholyte can further include an additive selected from a complexation agent, such as, but not limited to, quaternary amines, methyl ethyl pyrrolidinium bromide (MEP), methyl ethyl morpholinium (MEM); and ionic strength adjuster, including various water-soluble salts. Each possibility represents a separate embodiment.

According to some embodiments, the chemical composition of the catholyte is different from the composition of the anolyte. The term “different chemical composition”, as used herein, refers to the catholyte, which includes at least one constituent, which is not present in the anolyte, and vice versa. In further embodiments, the catholyte comprises cations which are the same as the cations contained in the feedwater. In still further embodiments, the anolyte comprises anions which are the same as the anions contained in the feedwater.

Each one of the anolyte and the catholyte can be acidic, neutral, or alkaline. Each possibility represents a separate embodiment. In certain embodiments, the anolyte is alkaline. In additional embodiments, the catholyte is acidic. The hydroxyl and/or hydronium ions can be used as reactants in the oxidation and/or reduction reaction, as counterions or to adjust the pH to desired levels, in accordance with the chosen type of the DFC, as known in the art.

In some embodiments, the catholyte contains the same anions as the anions contained in the feedwater. In some embodiments, the catholyte comprises halide anions, such as chloride, fluoride, bromide, and iodide. Each possibility represents a separate embodiment. In some exemplary embodiments, the catholyte comprises chloride ions.

According to some embodiments, the catholyte comprises at least about 10 mM of Cl⁻ anions. According to further embodiments, the catholyte comprises at least about 20 mM of Cl⁻ anions. According to still further embodiments, the catholyte comprises at least about 50 mM of Cl⁻ anions. According to yet further embodiments, the catholyte comprises at least about 100 mM of Cl⁻ anions. According to additional embodiments, the catholyte comprises about 10 mM to about 500 mM of Cl⁻ anions, including each value within the specified range. According to other embodiments, the catholyte comprises about 10 mM to about 200 mM of Cl⁻ anions, including each value within the specified range.

According to some embodiments, the catholyte comprises at least about 10 mM of Cl⁻ anions during the electrochemical operation of the DFC. According to further embodiments, the catholyte comprises at least about 20 mM of Cl⁻ anions during the electrochemical operation of the DFC. According to still further embodiments, the catholyte comprises at least about 50 mM of Cl⁻ anions during the electrochemical operation of the DFC. According to yet further embodiments, the catholyte comprises at least about 100 mM of Cl⁻ anions during the electrochemical operation of the DFC. According to additional embodiments, the catholyte comprises about 10 mM to about 500 mM of Cl⁻ anions, including each value within the specified range, during the electrochemical operation of the DFC. According to other embodiments, the catholyte comprises about 10 mM to about 200 mM of Cl⁻ anions, including each value within the specified range, during the electrochemical operation of the DFC.

The anolyte, the catholyte or both can contain dissolved gaseous species, such as, for example, oxygen or hydrogen gas.

The feedwater, which is deionized by the DFC of the present invention can be selected from seawater, brackish water, hard water, wastewater and organic streams needing remediation.

Each possibility represents a separate embodiment. The term “feedwater”, as used herein, is therefore meant to encompass aqueous solutions, organic liquids, and mixtures thereof.

The deionization process according to the principles of the present invention, provides removal of charged species from the feedwater. However, the present deionization process can also be applied to neutral species in the feedwater stream, by ionizing and/or radicalizing said species, thereby making them amenable to removal. Accordingly, in some embodiments, the method of deionization of a liquid comprises inputting energy into the DFC system to ionize and/or radicalize uncharged species in the feedwater. According to some embodiments, the step of inputting energy is performed during the discharging of the DFC. According to other embodiments, the step of inputting energy is performed before the discharging of the DFC.

According to further embodiments, the step of inputting energy is performed by applying at least one of a high voltage, heat, sonication, or electromagnetic radiation to the DFC. Each possibility represents a separate embodiment of the invention.

According to some embodiments, the feedwater comprises at least about 10 mM of Cl⁻ anions. According to further embodiments, the feedwater comprises at least about 20 mM of Cl⁻ anions. According to still further embodiments, the feedwater comprises at least about 50 mM of Cl⁻ anions. According to yet further embodiments, the feedwater comprises at least about 100 mM of Cl⁻ anions. According to additional embodiments, the feedwater comprises about 10 mM to about 500 mM of Cl⁻ anions, including each value within the specified range. According to other embodiments, the feedwater comprises about 10 mM to about 200 mM of Cl⁻ anions, including each value within the specified range.

The deionization process is based on the redox reaction of the oxidant, which can be present in the catholyte, and the reductant, which can be present in the anolyte. During operation of the DFC, the half-cell reactions of the oxidant and the reductant induce electrical current in the external electric circuit connecting the cathode and the anode and also give rise to a spontaneous ionic current between the cathode and the anode within the cell. Without wishing to being bound by theory or mechanism of action, said ionic current drives ion removal from the feedwater flowing in the feedwater flow channel. When the reductant and the oxidant are not charged, formation of their redox reaction products during cell operation increases the overall positive charge in the anolyte flow channel and the overall negative charge in the catholyte flow channel. In certain such embodiments, the positively charged ions migrate from the feedwater flow channel to the catholyte flow channel and the negatively charged ions migrate to the anolyte flow channel, to balance the charge differences across the cell.

The reductant and the oxidant suitable for use in a DFC are usually carefully chosen to ensure that they and their redox reaction products are electrostatically blocked from entering the first feedwater flow channel through the first CEM and the first AEM. In order to allow the use of different types of DFC chemistries in the DFC of the present invention, more than one CEM and AEM can be employed in the cell, thereby forming additional feedwater flow channels.

The reductant and the oxidant suitable for use in a DFC can also be chosen to ensure that if they diffuse into the first feedwater flow channel through the first CEM and the first AEM, they recombine in the first feedwater flow channel to obtain a neutral non-ionic compound. In certain such embodiments, even if the oxidant is positively charged and the reductant is negatively charged, a single CEM and a single AEM can be employed in the cell and the DFC therefore includes a single feedwater flow channel.

According to some embodiments of the present invention, the concentrations of the reductant and the oxidant and/or the pH of the catholyte and the anolyte are controlled to minimize the diffusion of the reductant and the oxidant to the first feedwater flow channel through the first CEM and the first AEM. In certain such embodiments, even if the oxidant is positively charged and the reductant is negatively charged, a single CEM and a single AEM can be employed in the cell and the DFC therefore includes a single feedwater flow channel.

The DFC according to the principles of the present invention can be based on any type of a fuel cell, which employs ORR as its half-cell reaction at the cathode. Non-limiting examples of such fuel cells include proton exchange membrane fuel cell (PEMFC), alkaline fuel cell (AFC), dual electrolyte hydrogen-oxygen fuel cell, acid-base fuel cell, sulfur oxygen fuel cell, and metal-oxygen cell (such as, for example, zinc-oxygen, sodium-oxygen, lithium-oxygen, potassium-oxygen, magnesium-oxygen, calcium-oxygen, aluminum-oxygen, or iron-oxygen). Each possibility represents a separate embodiment. The DFC can also be organic-based, such as, for example, an oxygen-hydroquinone fuel cell. It is to be understood that air can be used instead of oxygen in the above-mentioned fuel cells, as is known in the art.

According to some embodiments, the DFC is a hydrogen-oxygen DFC. In certain embodiments, the hydrogen-oxygen DFC is a dual electrolyte hydrogen-oxygen DFC. In further embodiments, the oxidant further comprises oxygen gas being supplied to the cathode. In still further embodiments, the reductant further comprises hydrogen gas being supplied to the anode.

According to some embodiments, the DFC is an acid-base DFC. In further embodiments, the oxidant further comprises oxygen gas being supplied to the cathode.

According to some embodiments, the catholyte is an aqueous solution comprising HCl and an alkali metal or alkaline earth metal salt. According to some embodiments, the anolyte is an aqueous solution comprising NaOH and an alkali metal or alkaline earth metal salt. The alkali metal or alkaline earth metal salt can include, for example, sodium, potassium, lithium, calcium, magnesium, or strontium cations and/or chloride, fluoride, bromide, iodide, sulfate, bicarbonate, phosphate, or nitrate anions. Each possibility represents a separate embodiment. According to certain embodiments, the catholyte comprises HCl and NaCl. According to other embodiments, the anolyte comprises NaOH and NaCl.

The concentration of the protons and hydroxyl ions in the catholyte and anolyte can be carefully chosen to maximize the deionization efficiency. High concentrations of H⁺ and OH⁻ provide a higher voltage difference between the anode and the cathode (i.e., OCV), thereby increasing the energy of the discharge and enhancing the driving force for the ion removal. On the other hand, high concentrations of said ions may increase their diffusion into the feedwater flow channel, such that the ionic current through the CEM and AEM would include mainly H⁺ and OH⁻, instead of the feedwater ions diffusion, resulting in a less efficient deionization.

In some embodiments, the DFC is a hydrogen-oxygen fuel cell. The reversible half-cell and overall reactions are presented in Equations 1-3 below.

H_{2(g)}+2OH⁻_{(aq)}→2e⁻+2H₂O₍ₗ₎, Equation (1), anode half-cell reaction;

O_{2(g)}+4H⁺_{(aq)}+2e⁻→2H₂O₍ₗ₎, Equation (2), cathode half-cell reaction; and

2H_{2(g)}+O_{2(g)}→2H₂O₍ₗ₎ Equation (3), overall reaction.

Without wishing to being bound by theory or mechanism of action, it is contemplated that since the catholyte and the anolyte are separated by a CEM, an AEM, and a feedwater flow channel, it is possible to use an anolyte and a catholyte having different acidity levels. In certain such embodiments, the hydrogen-oxygen DFC is a dual electrolyte hydrogen-oxygen DFC, which employs two different types of electrolytes (i.e., acidic catholyte and alkaline anolyte), thereby increasing the OCV and the energy, which can be obtained from the DFC.

The oxidant of the hydrogen-oxygen DFC comprises oxygen gas, which can be supplied to the reaction site at the interface between the catholyte and the cathode through the gas diffusion layer of the cathode. Cathode half-cell reaction also involves an hydronium ion (or proton). In certain such embodiments, the oxidant further comprises an hydronium ion. The product of the oxidant reduction reaction is water, which is also present in the catholyte. The catholyte can be in a form of an acidic aqueous solution. The catholyte can further include counter ions, such as, for example, halide anions. In some embodiments, the catholyte comprises HCl. The concentration of HCl in the catholyte can range from about 10 mM to about 1 M, including each value within the specified range. In further embodiments, the catholyte comprises HCl and NaCl. In still further embodiments, the concentration of NaCl ranges from about 10 mM to about 1 M, including each value within the specified range.

In the hydrogen-oxygen DFC, the reductant is hydrogen, which is supplied to the reaction site in the interface between the anolyte and the anode through the gas diffusion layer of the anode. Anode half-cell reaction also involves hydroxyl ions. In certain such embodiments, the reductant further comprises hydroxyl ions. The reductant oxidation reaction product is also water, which is present in the anolyte. The anolyte can be in a form of an alkaline aqueous solution. In certain embodiments, the anolyte comprises chloride anions. In further embodiments, the anolyte comprises NaOH and NaCl.

In some embodiments, the DFC is an acid-base fuel cell. The reversible half-cell and overall reactions are presented in Equations 4-6 below.

4OH⁻_{(aq)}→4e⁻+O_{2(g)}+2H₂O₍ₗ₎, Equation (4), anode half-cell reaction;

O_{2(g)}+4H⁺_{(aq)}+4e⁺→2H₂O₍ₗ₎, Equation (5), cathode half-cell reaction; and

4OH⁻_{(aq)}+4H⁺_{(aq)}→4H₂O₍ₗ₎, Equation (6), overall reaction.

In the acid-base DFC, the oxidant comprises oxygen gas, which can be supplied to the reaction site at the interface between the catholyte and the cathode through the gas diffusion layer of the cathode. Cathode half-cell reaction also involves an hydronium ion (or proton). In certain such embodiments, the oxidant further comprises hydronium ions. The product of the oxidant reduction reaction is water, which is also present in the catholyte. The catholyte can be in a form of an acidic aqueous solution. The catholyte can further include counter ions, such as, for example, halide anions. In some embodiments, the catholyte comprises HCl. The concentration of HCl in the catholyte can range from about 10 mM to about 1 M, including each value within the specified range. In further embodiments, the catholyte comprises HCl and NaCl. In still further embodiments, the concentration of NaCl ranges from about 10 mM to about 1 M, including each value within the specified range.

In the acid-base DFC, the reductant is hydroxide ions, which are present in the anolyte. The anolyte can, therefore, be in a form of an alkaline aqueous solution. The anolyte can further include counter ions, such as, for example, alkali metal or alkaline earth metal cations. The reductant oxidation reaction products include water, which is present in the anolyte, and oxygen gas, which can be resupplied to the cathode or which can be freely released through the anode to the cell ambiance. In some embodiments, the anolyte comprises NaOH. In certain embodiments, the anolyte comprises chloride anions. In further embodiments, the anolyte comprises NaOH and NaCl.

According to certain aspects and embodiments, the present invention provides a method of deionization of a liquid, the method comprising: (a) passing feedwater to be deionized through the DFC, wherein the feedwater is continuously cycled through the feedwater flow channel, the catholyte is continuously cycled through the catholyte flow channel and the anolyte is continuously cycled through the anolyte flow channel, (b) supplying oxidant (e.g. oxygen gas) to the cathode and reductant (e.g. hydrogen gas) to the anode, and (c) discharging the DFC to produce electricity and deionized liquid.

The present invention further comprises a method of preparing a catalyst according to the present invention, which includes, inter alia, a pyrolysis step, that is performed at a defined temperature range in order to provide a chloride-tolerant and electrocatalytically efficient ORR catalyst. Without wishing to be bound by theory or mechanism of action, the catalyst is believed to mitigate the surface poisoning by forming C-Cl bonds which (a) act as a co-catalyst for ORR and (b) reduce the number of metal sites occupied by chloride ions, thereby increasing the number of metal active sites which are available for ORR.

The term “chloride-tolerant”, as used herein, is meant to encompass a catalyst providing an ORR activity in a FDC which is substantially maintained in the presence of at least about 20 mM of chloride ions (Cl⁻), at least about 50 mM of chloride ions (Cl⁻), or at least about 100 mM of chloride ions (Cl⁻). Each possibility represents a separate embodiment. As used herein, substantially maintaining the ORR activity refers to an ORR activity which decreases in less than 25%, 20%, 15%, 10%, 5%, 2%, or 1% in the presence of Cl⁻ ions as compared to the ORR activity in the absence of Cl⁻ ions. Each possibility represents a separate embodiment.

It has further been discovered that the Fe—N—C catalyst which preparation involved pyrolysis at 900° C. had higher catalytic activity in the ORR as compared to the catalysts prepared at lower or higher pyrolysis temperatures. It is also been discovered that the Co—B—C—N catalyst which preparation involved pyrolysis at 1,000° C. had higher catalytic activity in the ORR as compared to the catalysts prepared at lower or higher pyrolysis temperatures.

Thus, according to the various aspects and embodiments of the present invention, the preparation method comprises subjecting a precursor comprising a zeolitic imidazolate framework (ZIF) and non-platinum group metal ions to pyrolysis at a temperature ranging from above 800° C. to below 1,100° C., including each value within the specified range. In specific aspects and embodiments, a Cl⁻-tolerant Fe—N—C catalyst is prepared by a method comprising: (a) providing a zeolitic imidazolate framework (ZIF) comprising Fe ions; and (b) pyrolyzing the ZIF of step (a) at a temperature ranging from above 800° C. to below 1,000° C., including each value within the specified range. According to some embodiments, the ZIF is pyrolyzed at a temperature of about 900° C. In other specific aspects and embodiments, a Cl⁻-tolerant Co—B—C—N catalyst is prepared by a method comprising: (a) providing B-doped zeolitic imidazolate framework (ZIF) comprising Co ions; and (b) pyrolyzing the ZIF of step (a) at a temperature ranging from above 900° C. to below 1,100° C., including each value within the specified range. According to some embodiments, the ZIF is pyrolyzed at a temperature of about 1,000° C.

The term “zeolitic imidazolate framework” or “ZIF”, as used herein, refers to a metal-organic frameworks (MOFs) compound which is composed of tetrahedrally-coordinated transition metal ions connected by imidazolate linkers.

The ZIF can be prepared by mixing a source of non-platinum group metal ions with imidazole or a derivative thereof. Non-limiting examples of suitable imidazoles and imidazole derivatives include 2-methylimidazole, imidazole, 2-ethylimidazole, and benzimidazole. Each possibility represents a separate embodiment. In certain embodiments, the imidazole is 2-methylimidazle.

The source of the non-Pt group metal can be a salt of a transition metal ion, such as, but not limited to, a nitrate, acetate, chloride, oxalate, and sulfate salts. Each possibility represents a separate embodiment. In some exemplary embodiments, said source is a nitrate salt.

According to some embodiments, the ZIF is prepared by first mixing the imidazole or a derivative thereof with a first source of the non-platinum group metal ions and then combining the obtained mixture with a second source of non-platinum group metal ions. Said first metal ions can be ions of a transition metal selected from Zn, Mg, Cu, Ag, and Ni, or any combination thereof. Each possibility represents a separate embodiment. In certain embodiments, the first source of the non-platinum group metal ions is Zn(NO₃)₂ and the second source of metal ions is Fe(NO₃)₃·9H₂O or (Co(NO₃)₂·6H₂O). Each possibility represents a separate embodiment. In some embodiments, the second source of metal ions is added gradually to the mixture of Zn(NO₃)₂ and 2-methylimidazole, e.g., in a dropwise manner. The reaction medium can include an organic solvent, in which the reactants are dissolved, e.g., ethanol or methanol. In some exemplary embodiments, the solvent is ethanol. When B-doped zeolitic imidazolate framework (ZIF) is prepared, the 2-methylimidazole is first mixed with boronic acid followed by the sequential addition of the first and second source of non-platinum group metal ions as described herein.

Following the mixing step, the obtained ZIF can be gradually dried at a temperature above room temperature, e.g., above 50° C.

According to certain embodiments, the obtained ZIF is ZIF-8 or ZIF-67 with each possibility representing a separate embodiment.

The obtained ZIF is further subjected to a pyrolysis treatment. Pyrolysis is the heating of a material in the absence of (atmospheric) oxygen. According to the principles of the present invention, it is prerequisite that the pyrolysis is performed at a temperature above 800° C. but below 1,100° C., including each value within the specified range. Without wishing to being bound by theory or mechanism of action, it is contemplated that the particular pyrolysis temperature affords for the formation of a Cl⁻-tolerant catalyst, which is highly efficient in the oxygen reduction reaction. For Fe—N—C catalyst, the pyrolysis temperature preferably ranges between 850° C. and 950° C., including each value within the specified range. In some exemplary embodiments, the pyrolysis temperature is about 900° C. For Co—B—C—N catalyst, the pyrolysis temperature preferably ranges between 950° C. and 1,050° C., including each value within the specified range. In some exemplary embodiments, the pyrolysis temperature is about 1,000° C.

After the pyrolysis step, the obtained catalyst can be subjected to an acid treatment.

As used herein and in the appended claims the singular forms “a”, “an,” and “the” include plural references unless the context clearly dictates otherwise. Thus, for example, reference to “an ion” includes a plurality of such ions. It should be noted that the term “and” or the term “or” is generally employed in its sense including “and/or” unless the context clearly dictates otherwise.

As used herein, the term “about”, when referring to a measurable value such as an amount, a temporal duration, and the like, is meant to encompass variations of ±20%, more preferably ±10%, even more preferably ±5%, and still more preferably ±1% from the specified value, as such variations are appropriate to perform the disclosed methods. Each possibility represents a separate embodiment.

The term “plurality” as used herein, means two or more.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Materials and Methods

### Materials

Iron (III) nitrate nonahydrate (Fe(NO₃)₃·9H₂O), zinc nitrate hexahydrate (Zn(NO₃)₂·6H₂O), and 2-methyl imidazole (2-MeIm) were purchased from Sigma Aldrich, Germany. Ethanol (C₂H₅OH) was procured from Gadot Chemicals, Israel. Pt/C (40 wt. % Pt on activated carbon black) and Nafion® ionomer (5 wt %) were purchased from Fuel cell store, U.S. All chemicals were used without further purification. Deionized (DI) water (18.2 MΩ cm) was obtained using a Synergy® Water Purification System (Millipore, Germany).

### Methods

### Synthesis of Fe—N/C Catalysts

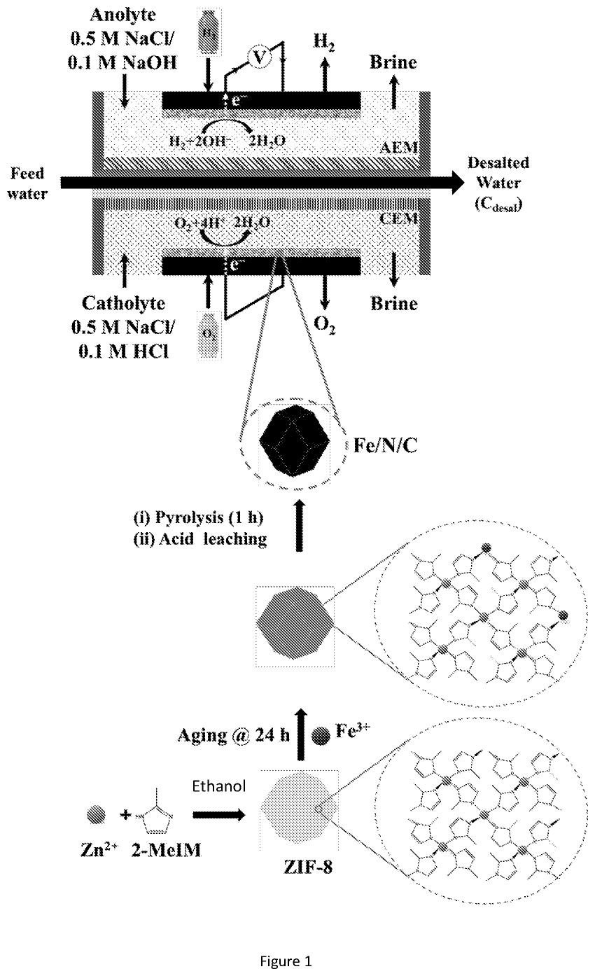

FIG. 1 (bottom) shows a schematic representation of the synthesis procedure of Fe—N/C catalyst according to embodiments of the present invention. Zeolitic imidazolate framework-8 (ZIF-8) was obtained by dissolving 2.05 g of 2-MeIM in 50 mL of ethanol followed by the slow addition of Zn(NO₃)₂·4H₂O (50 mM, 50 mL) and stirring for 1 h under ambient conditions. 50 mL of 2.5, 5 or 7.5 mM of an ethanolic solution of Fe(NO₃)₃·9H₂O were added to the mixture dropwise until brown colored Fe-ZIF-8 was produced. The reaction mixture was continuously stirred for 24 h to allow maximum interaction of Fe³⁺ ions with ZIF-8. The Fe-ZIF-8/ethanol solution was dried at 80° C. overnight to derive the catalyst precursor. The dried residue was then subjected to pyrolysis at 800, 900 and 1,000° C. with a heating rate of 2° C. min⁻¹ under Ar gas flow. After pyrolysis, the black products were acid leached in 0.5 M H₂SO₄ at 80° C. for 5 h, then filtered, washed with copious amounts of water and dried at 80° C. overnight to obtain the final catalysts denoted Fe/N/C-800, Fe/N/C-900, and Fe/N/C-1000 indicating the different pyrolysis temperatures. The pyrolysis step of the synthesis is considered critical due to the transformation of organic moiety to highly porous carbon structure and melting of volatile metals such as Zn, providing a nanotube-like structure of the catalyst.

Physiochemical Characterizations To study the crystal phase of the Fe/N/C catalysts, X-ray powder diffraction (XRD) using a Rikagu SmartLab 9 kW (Rigaku) diffractometer with Cu—Kα (1.54 Å) as the X-ray source was employed. To study structural defects in the carbon framework, Raman spectroscopy was utilized with a Horiba Jobin Yvon instrument (LabRAM HR Evolution). To visualize surface morphologies of as-synthesized ZIFs and Fe/N/C catalyst, high resolution scanning electron microscopy (HR-SEM) images were recorded using FEI Nova NanoSEM-230 instrument. To identify nanoparticle distribution and carbon morphology, transmission electron microscope (TEM) and high-resolution transmission electron microscope (HR-TEM) images were acquired using a FEI Tecnai G2 T20 and FEI Titan Themis Cs-Corrected HR-S/TEM, respectively. To identify the electronic features of C, N, O and Fe, X-ray photoelectron spectra (XPS) were recorded using a Thermo VG Scientific Sigma Probe system. To evaluate the specific surface area and pore distribution, N₂ adsorption and desorption isotherms were measured using 3Flex, Micromeritics at −196° C. Prior to measurements, samples were degassed at 180° C. for 12 h. The specific surface area of each catalyst was calculated from N₂ adsorption and desorption isotherms by means of the Brunauer-Emmett-Teller (BET) method.

### Electrochemical Characterization

The electrochemical tests were performed using a VSP (Bio-Logic Science Instruments, France) electrochemical workstation with standard three-electrode cell operating at 25° C. A graphite rod and reversible hydrogen electrode (RHE, ALS, Japan) were used as counter and reference electrodes, respectively. The working electrode was composed of a glassy carbon electrode (GCE) with a diameter of 5 mm (ALS Co. Ltd., Japan). Prior to use, the GCE was polished using a 0.3 m alumina powder followed by washing ultrasonically in water and ethanol to obtain a clean and smooth surface. For the catalyst ink, 7.8 mg of each catalyst were mixed with 30 μL of Nafion ionomer (5 wt %) and ultrasonically dispersed in 0.97 mL of a 1:4 ethanol:water mixture for 30 min. Subsequently, 15 μL of the catalyst ink were dropped onto the polished GCE surface and dried at room temperature. The catalyst loading of ˜0.6 mg cm⁻² was applied to the GCE for all samples.

The electrochemical characterizations were performed using cyclic voltammograms (CVs) and linear sweep voltammograms (LSVs) with RRDE-3A (Ver1.2, Japan) in 0.1 M aqueous HClO₄ electrolyte. Perchlorate was used as it is known not to poison Pt catalyst material. CVs were recorded in N₂ and O₂ saturated electrolyte in the potential range between 0 to 1 V at a scan rate of 50 mV s⁻¹. To study ORR kinetics, LSVs were performed in O₂ saturated electrolyte in the potential range between 0 to 1 V on the rotating working electrode operating at 1,600 rpm at a scan rate of 5 mV s⁻¹. For Tafel plots, the kinetic current was calculated using a mass-transport correction given by

$${j}_{k} = \frac{j \times {j}_{L}}{{j}_{L} - j} , \qquad Equation ( 7 )$$

where jₖ is the mass-transport corrected kinetic current density, j_{L} is the measured limiting current density and j is the measured current density.

Chronoamperometry was performed by holding the potential of the working electrode at 0.2 V vs. RHE for 50 h in O₂ saturated electrolyte, and the measured decay current data was compared with that of commercial Pt/C catalyst. The chloride tolerance test was performed by adding 0.1 M aqueous HCl solution into O₂-saturated electrolyte solution, after which LSV was performed at a rotational rate of 1,600 rpm with a scan rate of 5 mV s⁻¹. To evaluate the durability of Fe/N/C and Pt/C catalysts, continuous potential cycles were performed from 0.05 to 1 V (vs. RHE) repeated 5,000 times in O₂ saturated 0.5 M aqueous NaCl electrolyte with a scan rate of 50 mV s⁻¹. After 5,000 potential cycles, LSVs were recorded from 1 to 0 V (vs. RHE) with a scan rate of 5 mV s⁻¹ at a rotational rate of 1,600 rpm. To calculate peroxide yield and the number of electrons transferred during the ORR process, rotating ring-disk electrode (RRDE) measurements were carried out in O₂ saturated electrolyte from 0 to 1 V at a rotating rate of 1,600 rpm with a scan rate of 5 mV s⁻¹. RRDE was performed with a GC disk of 4 mm diameter and a Pt ring of 1 mm thickness. In order to identify the pathway, RRDE measurements were carried out for varying catalyst loadings of 100, 200, 400, 600, 800, and 1000 μg cm⁻². The number of electrons transferred and peroxide yield were calculated using the following equations,

$$\% {H}_{2} {O}_{2} = 200 \times \frac{{I}_{r} / N}{{I}_{d} + {I}_{r} / N} , \qquad Equation ( 8 )$$

$$n = 2 \times \frac{2 {I}_{d}}{{I}_{d} + {I}_{r} / N} , \qquad Equation ( 9 )$$

where n is number of electrons transferred during ORR, I_{d} is the disk current, Iᵣ is the ring current, and N is the current collection efficiency of Pt ring which is 0.4.

### Fabrication and Performance Evaluation of the Desalination Fuel Cell

The desalination fuel cell (DFC) was composed of three compartments, catholyte, anolyte and desalination compartments (FIG. 1, top). The desalination compartment was cut into a single Viton rubber gasket of 0.5 mm thickness. Flow channel dimensions were 10.5 by 1.5 cm with an active area of 15.75 cm². The desalination channel was sandwiched by an anion and cation exchange membrane (AEM and CEM) (Neosepta AMX and CMX-fg, Tokuyama, Japan). The anolyte channel adjacent to the AEM was composed of two Viton rubber gaskets of 1 mm thickness that were cut into the same dimensions as in the desalination channel. A catholyte channel adjacent to the CEM was made by cutting one 1 mm Viton rubber gasket and one 1.6 mm expanded PTFE (e-PTFE) gasket into the same dimensions as in the desalination channel. Two custom-milled planar graphite current collectors with interdigitated flow fields of 1 mm wide and 1 mm deep, were used to flow the H₂ (99.999% purity, Maxima, Israel) gas to the anode and O₂ (99.5% purity, Maxima, Israel) gas to the cathode. The anode was 0.5 mg/cm² 60% Pt on Vulcan carbon cloth gas diffusion electrode (GDE) (Fuel cell store, Texas, USA) and was placed inside ˜0.3 mm thick recess in the anode current collector. The cathode was placed inside ˜0.3 mm thick recess on a 1.6 mm ePTFE gasket, and was either a Nafion-bound 2 mg cm⁻² platinum black catalyst layer on carbon cloth GDL with PTFE-treated MPL (Fuel cell store, Texas, USA), or the custom synthesized electrode containing Fe—N/C catalyst. Both anode and commercial cathode were composed of three layers, a woven gas diffusion layer (GDL), and a microporous layer (MPL) that was coated with PTFE-treated, Nafion-bound Pt/C catalyst. All solutions were pumped to the cell using peristaltic pumps (Masterflex, Cole Parmer, USA) from external tanks in a single pass mode. The anolyte was a solution of 0.5 M NaCl/0.1 M NaOH, the catholyte 0.5 M NaCl/0.1 M HCl and the feed stream to the desalination channel was 0.5 M NaCl. All flow rates were constant during the experiments and set to 1.5 mL min⁻¹ for the anolyte and catholyte, 500 mL min⁻¹ for oxygen and hydrogen gases, and 0.5 mL min⁻¹ for the desalination channel. Polarization curve measurements were conducted utilizing different cathodes, the commercial Pt/C and the custom-synthesized Fe/N/C. Constant currents were delivered from the cell to an electrochemical workstation (Biologic VSP, France), in steps of 0.63 mA cm⁻², 10 min for each step, to allow reaching an equilibrium cell voltage and ionic conductivity (TraceDec, Innovative Sensor Technologies GmbH, Austria).

### Comparative Example—Effect of Chloride Ions on the State-of-the-Art Platinum Catalyst

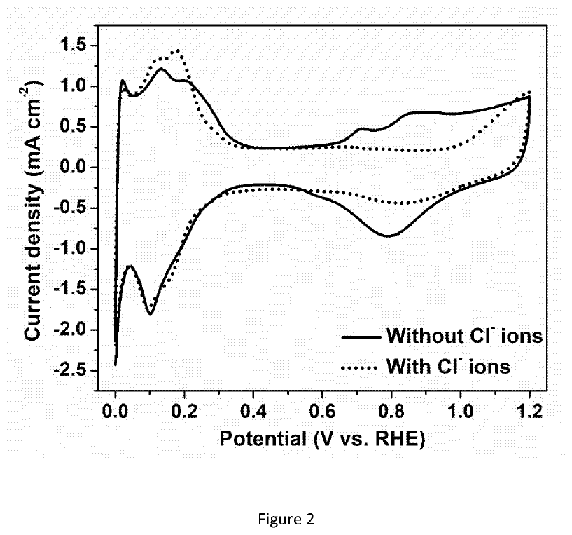

The state-of-the-art catalyst suffers from the increased overpotential in chloride environment at DFC cathodes. Thereby, Pt based catalysts are highly susceptible to surface poisoning which largely limits their use in DFC applications. The comparative cyclic voltammograms (CVs) of commercial Pt/C (Alfa Aeser, U.K.) recorded in 0.1 M aqueous HClO₄ electrolyte in the presence or absence of C1 ions are shown in FIG. 2. The introduction of Cl-ions was performed by adding 5 mL of 0.1 M aqueous HCl to the electrolyte. The electrochemical surface area was calculated for the Pt/C catalyst from the CV recorded with and without Cl⁻ ions in the electrolyte. Remarkably, the initial Pt/C ECSA was found to be ˜67 m² g⁻¹ which was reduced to ˜61 m² g⁻¹ after introducing the Cl⁻ ions to the electrolyte solution. It can therefore be concluded that Cl⁻ adversely affects Pt catalyst and is responsible for surface poisoning during potential scans. Notably, significant changes were observed in the higher potential region, where ORR takes place, which explains the influence of Cl⁻ ions towards Pt—O interaction.

### Example 1—Preparation of the Fe—N—C Catalyst

FIG. 1 (bottom) shows a schematic representation of the synthesis of Fe/N/C catalysts at different temperatures (800, 900 and 1,000° C.) followed by acid leaching. Initially, ZIF-8 was formed by the gradual addition of Zn²⁺ ions into a 2-MeIM solution and then Fe³⁺ ions were introduced into the ZIF-8 dispersion. Subsequently, Fe³⁺ ions were trapped into the ZIF-8 nanostructures and self-assembled Fe-doped ZIF-8 nanostructures were synthesized at room temperature. Upon slow solvent evaporation, Fe-ZIF-8 residue was collected and pyrolyzed at the desired temperature for 1 h under Ar flow. Successively, Fe/N/C active sites were introduced into highly graphitized porous carbon structure which acts as the catalytic center for dioxygen reduction. The obtained catalyst was further acid leached in 0.5 M aqueous H₂SO₄ at 80° C. for 5 h to remove unstable Fe species which were formed during pyrolysis. In addition to removing inactive Fe species, acid leaching further created additional structural defects in the carbon network thereby providing the acid stable active material in the catalyst.

### Example 2—Physiochemical Characterization of the Fe—N—C Catalyst

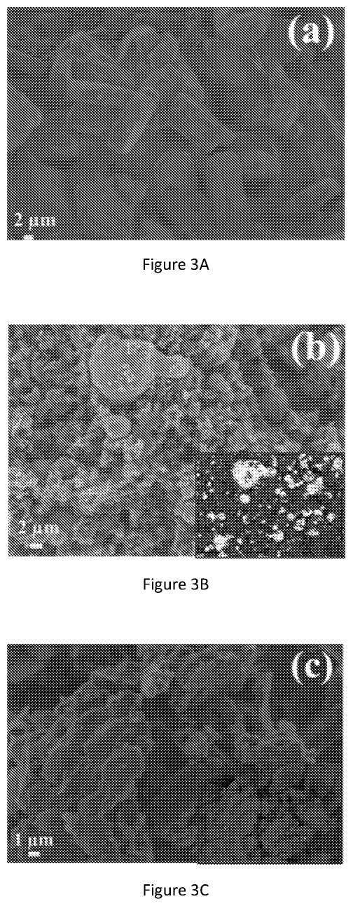

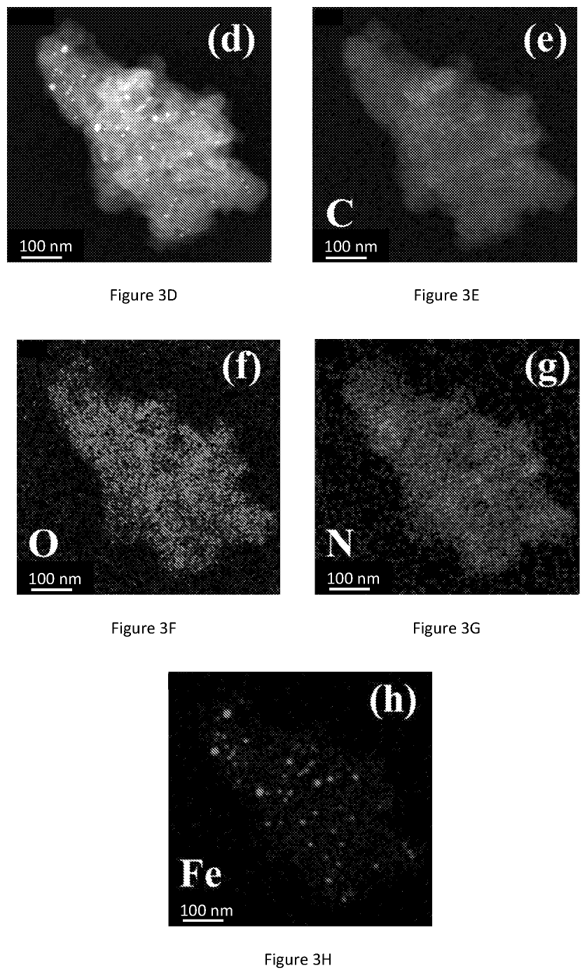

The effect of synthesis temperature, notably variations between 800, 900, and 1,000° C., on the surface morphology of the catalysts was visualized using HRSEM (FIGS. 3A-3C). The dried Fe-ZIF-8 showed a polyhedral morphology with a size of a few microns (FIG. 3A). Pyrolyzed and acid-leached materials showed indefinite morphologies wherein the polyhedral structures were destroyed upon high temperature treatment (FIGS. 3B-3C). When imaged using energy selective backscattered (ESB) electrons, metal/metal carbide particles were shown to highly accumulate on the carbon network as seen in the bright spots at the inset of FIG. 3B. It is noteworthy that the intensity of the bright spots was significantly reduced in the acid-leached samples. The reduction is explained by the removal of unstable metal species from the pyrolyzed sample.

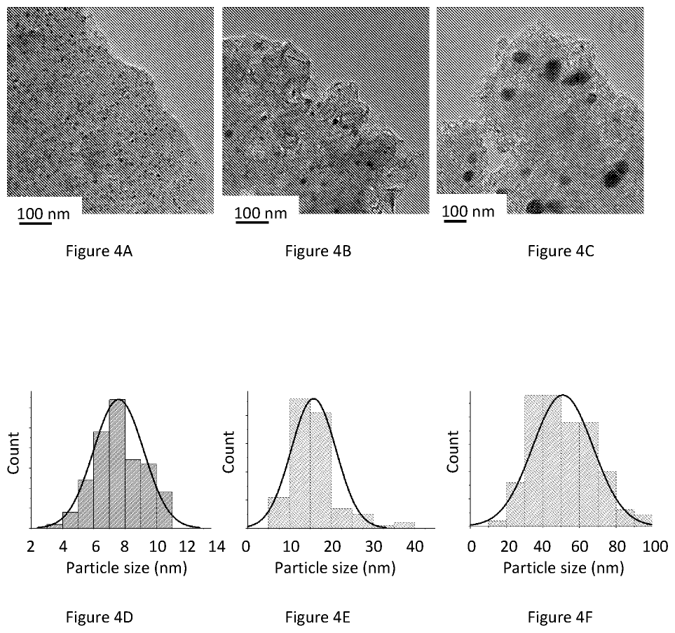

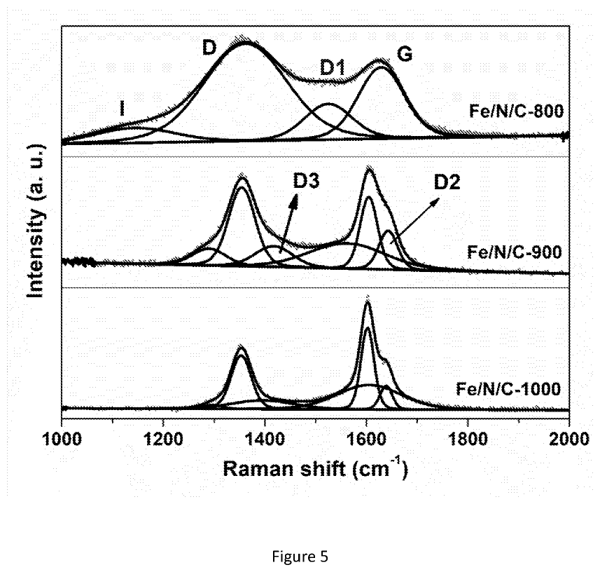

FIGS. 4A, 4B, and 4C show TEM micro-images of Fe/N/C catalysts synthesized at 800, 900, and 1,000° C., respectively. The images show that the carbon structure in all catalysts was composed of a nano-sized highly porous framework. Significantly, uniform distribution of Fe nanoparticles was observed in the graphitized carbon matrix, however, change in the metal particle size was seen when increasing the pyrolysis temperature from 800 to 1,000° C. Particle size distributions are shown in FIGS. 4D, 4E, and 4F for Fe/N/C-800, Fe/N/C-900, and Fe/N/C-1000 catalysts, respectively. The nanoparticles in the sample pyrolyzed at 800° C. were distributed throughout with an average particle size of about 8 nm (FIG. 4D), whereas, the average particle size of particles pyrolyzed at 900 and 1,000° C. were ˜16 and 51 nm (FIGS. 4E and 4F), respectively. Notably, graphitized carbon structures were observed largely at the edges of Fe/N/C-900 and Fe/N/C-1000 catalysts attributed to the evaporation of Zn metal from the matrix. Graphitic lattice fringes were observed largely for the Fe/N/C-900 and Fe/N/C-1000 catalysts, indicating significant graphitized carbon. The graphitic lattice fringes were not observed in the Fe/N/C-800 catalyst, suggesting negligible or absence of graphitic carbon.

EDS mapping showed that C, N and O were uniformly distributed, and Fe metal was distributed with a random particle size as evident from the light/bright colors in the Fe/N/C-900 catalyst (FIGS. 3D-3H).

Information on the degree of graphitization and the degree of disorder was obtained using Raman spectroscopy (FIG. 5). The Raman spectra showed two major bands in the first order region (1,000-1,800 cm⁻¹), typically, a disordered D-band (˜1,350 cm⁻¹) and a graphite G band (˜1,550 cm⁻¹). The D-band is associated with the structural defects in the sp2 carbon atoms with a A₁g symmetry mode vibration and the G-band is associated with an in-plane vibration of carbon 25 atoms with E₂g symmetry (D. G. Henry, I. Jarvis, G. Gillmore, M. Stephenson, Earth-Science Rev. 2019, 198, 102936). These two major bands consist of asymmetrical peaks and small humps that can be shown when deconvoluted into appropriate peaks (FIG. 5). Thus, for Fe/N/C-800, the spectrum is deconvoluted into four distinct peaks namely, I, D, D1 and G bands. The broad I-band at around 1,150 cm⁻¹ corresponds to the stretching vibrations of C—C and C═C of polyene structures with A₁g symmetry from the amorphous sp2 carbon. It is noteworthy that the I-band was shifted to a higher wavenumber (1,290-1,300 cm⁻¹) in Fe/N/C-900 and Fe/N/C-1000, representing decreased amorphous character in the catalysts. The change in full-width at half maximum (FWHM) of the D-bands is attributed to increased defective carbon structure and it is largely observed in the Fe/N/C-900 and Fe/N/C-1000 catalysts. The D1-band which appeared in all the catalysts is attributed to the presence of heteroatoms (X. Qu, Y. Han, Y. Chen, J. Lin, G. Li, J. Yang, Y. Jiang, S. Appl. Catal. B Environ. 2021, 295, 120311). In addition, D2 and D3 bands were found in Fe/N/C-900 and Fe/N/C-1000 catalysts at around 1,640 and 1,415 cm⁻¹, respectively. The D2-band, in general, is merged with the predominant G-band corresponding to the disordered nature inside the graphitic lattice with E2g symmetry, and the D3-band, in general, is recognized for the carbon with the micropores nature (M. F. Romero-Sarmiento, J. N. Rouzaud, S. Bernard, D. Deldicque, M. Thomas, R. Littke, Org. Geochem. 2014, 71, 7). Therefore, the catalysts pyrolyzed at 900 and 1,000° C. showed improved graphitic nature as well as defected carbon lattice. The degree of disorder was calculated to be 1.12, 1.10 and 0.75 using ID/IG ratio for Fe/N/C-800, Fe/N/C-900, and Fe/N/C-1000 catalysts, respectively. Surprisingly, lower degree of disorder was observed for the Fe/N/C-900 and Fe/N/C-1000 catalysts compared to the Fe/N/C-800 catalyst. Substantial increase in the graphitization results in the increase in the G-band intensity which is reflected in the decreased ID/IG ratio.

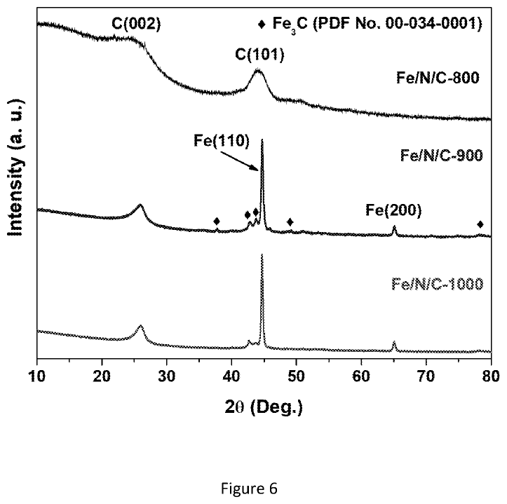

FIG. 6 shows comparative XRD patterns of Fe/N/C-800, Fe/N/C-900, and Fe/N/C-1000 catalysts. For Fe/N/C-800, two broad diffraction peaks were observed at around 260 and 440 corresponding to the (0 0 2) and (1 0 1) planes of carbon. No metallic peaks were identified, signifying that no metal aggregates or metal carbides were present in the catalyst as visualized by the TEM images. The characteristic diffraction peaks of metallic iron in the Fe/N/C-900 and Fe/N/C-1000 catalysts, were observed at around 44.7° and 65.10 which are assigned to the (1 1 0) and (2 0 0) planes. In addition to the metallic iron, low intense peaks were detected at around 37, 42, 43, 49, and 780 which are assigned to the (2 1 0), (2 1 1), (1 0 2), (2 2 1), and (1 3 3) planes of the Fe₃C phase, respectively (PDF No. 00-034-0001). The existence of carbides after pyrolysis was predominantly found while using organic ligands as the carbon source. In addition, the degree of graphitization increased with the increase in pyrolysis temperature as seen by the sharp C (0 0 2) peak. These findings are consistent with the Raman results (FIG. 5).

### Example 3—Electrochemical Characterization of the Fe—N—C Catalyst

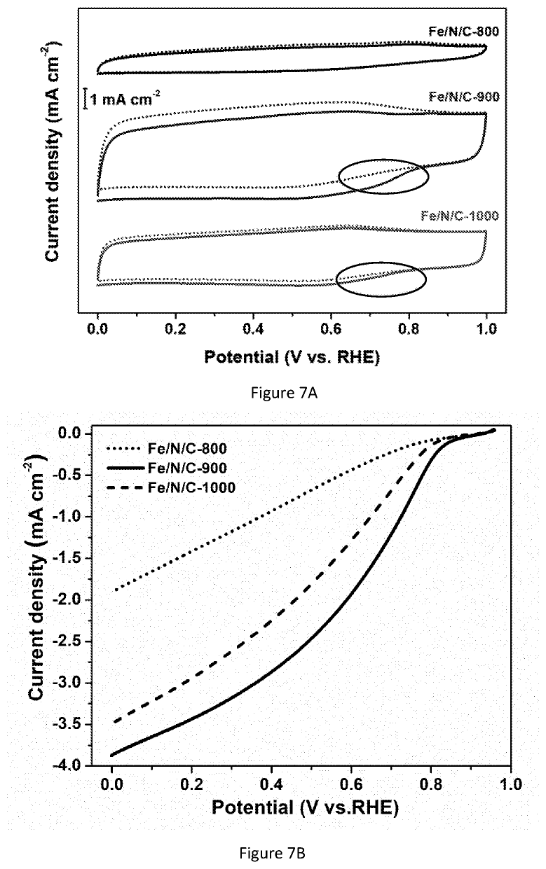

To investigate the ORR activity, CVs and LSVs were performed for the Fe/N/C-800, Fe/N/C-900, and Fe/N/C-1000 catalysts in 0.1 M aqueous HClO₄ electrolyte. FIG. 7A shows comparative CVs of Fe/N/C-800, Fe/N/C-900, and Fe/N/C-1000 catalysts recorded in N₂ and O₂ saturated electrolytes. The reduction peaks observed between about 0.6 to 0.8 V for the Fe/N/C-900 and Fe/N/C-1000 catalysts in O₂ saturated electrolyte (circled), were not replicated in N₂ saturated electrolyte, indicating typical ORR peaks. The reduction peaks were not extensively observed for the Fe/N/C-800 catalyst, likely due to reduced ORR activity.

To explore the ORR kinetics, RDE measurements were used in O₂ saturated electrolyte with a rotational rate of 1,600 rpm at a scan rate of 5 mV s⁻¹. FIG. 7B shows the LSV curves of the Fe/N/C-800, Fe/N/C-900, and Fe/N/C-1000 catalysts. Onset potential is one of the parameters to be considered when evaluating electrochemical ORR activity. The onset potentials of the Fe/N/C-800, Fe/N/C-900, and Fe/N/C-1000 catalysts were found to be 0.80, 0.85, and 0.83 V, respectively. In addition, the limiting current densities were calculated to be 1.9, 3.9, and 3.5 mA cm⁻² for the Fe/N/C-800, Fe/N/C-900, and Fe/N/C-1000 catalysts, respectively. The highest onset potential and limiting current density were observed for the Fe/N/C-900 catalyst which is likely due to the larger defects at the graphitic carbon lattice compared with that of the Fe/N/C-1000 catalyst. The lowest onset potential and limiting current density, and thus lowest ORR activity, were seen for the Fe/N/C-800 catalyst. Without being bound by any theory or mechanism of action, this may be attributed to the existence of low-order amorphous carbon in the Fe/N/C-800 catalyst, causing lower electrical conductivity. For the Fe/N/C-1000 catalyst, larger particle size (˜51 nm) of metallic iron and reduced nitrogen content (Table 1) were observed thereby resulting in lower ORR activity compared to that of the Fe/N/C-900 catalyst.

TABLE 1
Elemental analysis of the Fe/N/C-800, Fe/N/C-900
and Fe/N/C-1000 catalyst powders.

| Catalysts | C (%) | H (%) | N (%) |
|---|---|---|---|
| Fe/N/C-800 | 53.71 | 1.17 | 14.30 |
| Fe/N/C-900 | 85.16 | 0.48 | 0.74 |
| Fe/N/C-1000 | 78.99 | 0.17 | 0.67 |

To calculate ORR kinetics, Tafel plot was derived from the LSV data using Equation (7). The kinetic current densities at 0.8 V were calculated to be approximately 0.06, 0.41, and 0.19 mA cm⁻² for the Fe/N/C-800, Fe/N/C-900, and Fe/N/C-1000 catalysts, respectively. Accordingly, mass activities were also calculated at 0.8 V and found to be 0.09, 0.70, and 0.32 A g⁻¹ of the catalyst. The Tafel slopes for the Fe/N/C-900 and Fe/N/C-1000 catalysts were calculated and are outlined in Table 2. The Fe/N/C-900 catalyst exhibited lower slope values comparable to the Pt/C catalyst. Without being bound by any theory or mechanism of action, the superior performance of the catalyst pyrolyzed at 900° C. may be attributed to the iron particle size and the formation of a highly conductive N-doped graphitic carbon network.

TABLE 2
Comparative electro-kinetic parameters viz. onset potentials, limiting
current densities, kinetic current densities and mass activities
of the Fe/N/C-800, Fe/N/C-900, and Fe/N/C-1000 catalysts.

| | | Limiting | Kinetic current | Mass |
|---|---|---|---|---|
| | Onset | current | density | activity |
| | potential | density (mA | (mA/cm²) | (A/g) |
| | (V vs. | cm⁻² @ 0.1 | @ 0.8 V | @ 0.8 V |
| Catalysts | RHE) | V vs. RHE) | (vs. RHE) | (vs. RHE) |
| Fe/N/C-800 | 0.80 | 1.9 | 0.055 | 0.09 |
| Fe/N/C-900 | 0.85 | 3.9 | 0.416 | 0.70 |
| Fe/N/C-1000 | 0.83 | 3.5 | 0.191 | 0.32 |

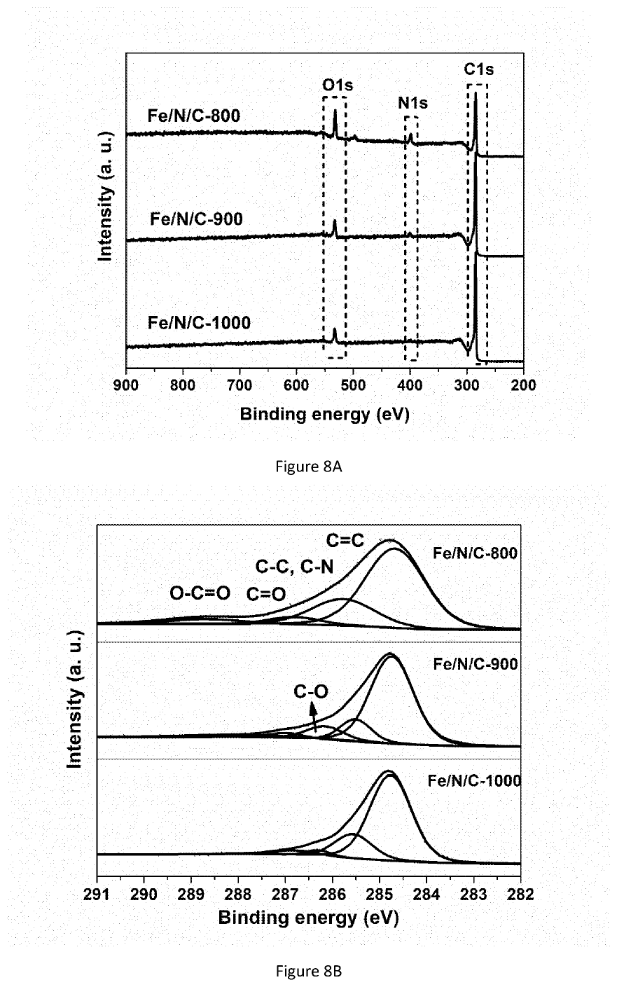

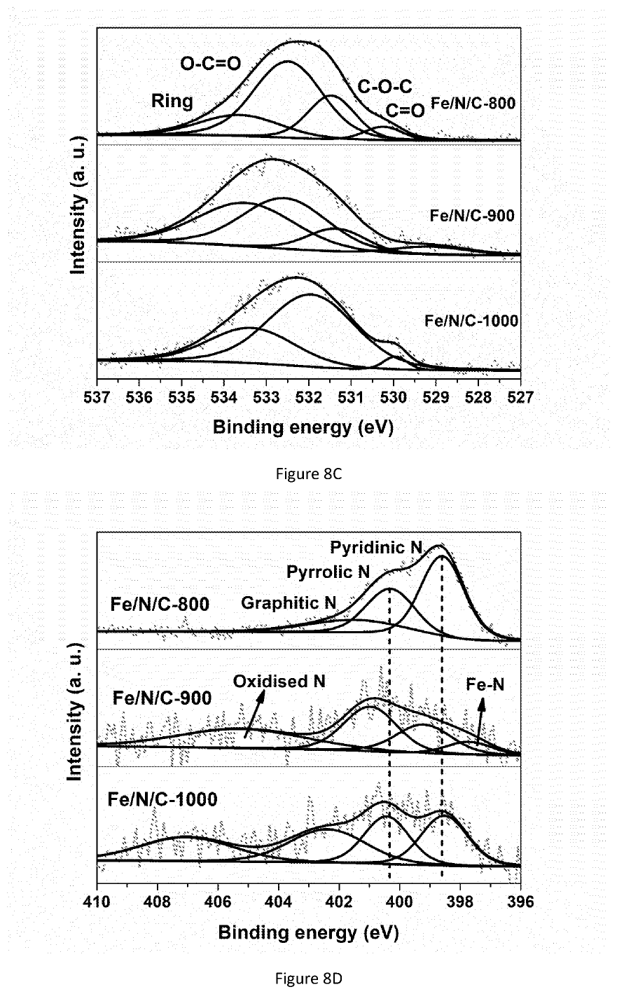

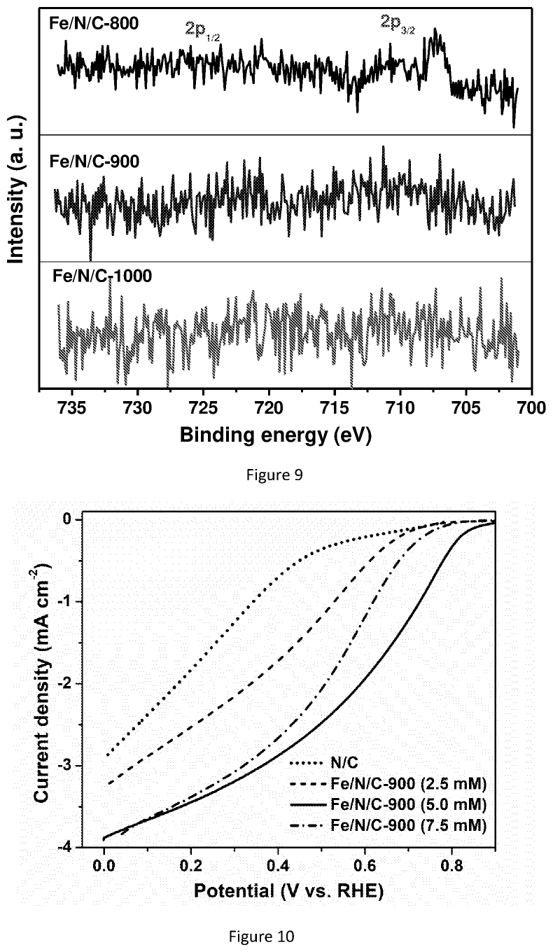

FIG. 8A shows a comparison of XPS spectra of the Fe/N/C-800, Fe/N/C-900, and Fe/N/C-1000 catalysts. The C1s, N1s, and O1s were clearly visible at their significant binding energy (284, 398, and 531 eV, respectively). However, Fe signals were suppressed due to the intense carbon peaks. FIG. 9 shows the low intensity high-resolution Fe2p peak. The high-resolution and deconvoluted spectra of C1s, O1s and N1s are presented in FIGS. 8B, 8C, and 8D respectively. The C1s spectrum at 284 eV was deconvoluted into different peaks corresponding to C═C, C—C, C—N, C—O and C═O functionalities (FIG. 8B). Likewise, the O1s peak was deconvoluted into four distinct peaks corresponding to C═O, C—O—C, O—C═O and O in the ring structures at the binding energy of ˜529, ˜531, ˜532 and ˜533 eV (FIG. 8C). Interestingly, for Fe/N/C-1000, the peak related to O—C═O was merged with the C—O—C peak and thus a broad peak was observed at 531.9 eV, indicating changes in the chemical environment due to higher pyrolysis temperature.

The decomposition of Zn-N species followed by Fe—N active species formation and graphitic-N conversion are largely related to the pyrolysis temperature and time duration (R. Ding, Y. Chen, P. Chen, R. Wang, J. Wang, Y. Ding, W. Yin, Y. Liu, J. Li, J. Liu, ACS Catal. 2021, 11(15), 9798). To investigate the different N species presented in the catalysts synthesized at the various pyrolysis temperatures, N1s peak was deconvoluted into several dissimilar peaks (FIG. 8D). For Fe/N/C-900, three major peaks were identified, predominantly pyridinic-N peak was observed at 398.6 eV followed by pyrrolic-N (400.2 eV) and broad graphitic-N (401.5 eV) peaks. In case of Fe/N/C-900, it is noteworthy that the pyridinic-N peak was shifted towards lower binding energy (397.7 eV) due to the presence of an Fe—N peak at 399.2 eV. This explains the interaction of metal and nitrogen creating active catalytic sites for dioxygen reduction during the electrochemical process (H. Zhang, H. T. Chung, D. A. Cullen, S. Wagner, U. I. Kramm, K. L. More, P. Zelenay, G. Wu, Energy Environ. Sci. 2019, 12(8), 2548). Notably, due to lower thermal stability of the pyridinic group at higher temperatures, pyridinic-N content was decreased when increasing pyrolysis temperature from 800 to 1,000° C. As temperature increased, pyridinic-N was converted into pyrrolic-N or graphitic-N as is observed for the Fe/N/C-900 and Fe/N/C-1000 catalysts (FIG. 8D). Without being bound by any theory or mechanism of action, although pyridinic-N alters the carbon band structure, creates dense p-states at the Fermi level, and decreases the work function, experimentally, it was not an effective candidate for the improved ORR (Z. Luo, S. Lim, Z. Tian, J. Shang, L. Lai, B. MacDonald, C. Fu, Z. Shen, T. Yu, J. Lin, J. Mater. Chem. 2011, 21(22), 8038). However, relatively higher electronegative graphitic-N modifies the electron cloud on the adjacent carbon atom and facilitates the electron transfer from C to N and also the backdonation from N to adjacent C atom, thus, facilitating the O₂ adsorption/dissociation on the adjacent carbon site (L. Lai, J. R. Potts, D. Zhan, L. Wang, C. K. Poh, C. Tang, H. Gong, Z. Shen, J. Lin, R. S. Ruoff, Energy Environ. Sci. 2012, 5(7), 7936). Therefore, increased graphitic-N species and the existence of Fe—N active species are potentially the reason for the improved ORR activity exhibited by the Fe/N/C-900 catalyst (FIG. 7B).

In addition, a peak at 405.3 eV was identified which was attributed to the presence of oxidized-N species on the catalyst. In case of the Fe/N/C-1000 catalyst, the existence of pyridinic-N, pyrrolic-N, graphitic-N and oxidized-N were detected at 398.5, 400.3, 402.3 and 407.0 eV, respectively. The graphitic-N peak was shifted to the higher binding energy, which can be attributed to the existence of another N species which affects the local chemical environment (S. Kabir, K. Artyushkova, A. Serov, B. Kiefer, P. Atanassov, Surf Interface Anal. 2016, 48(5), 300).

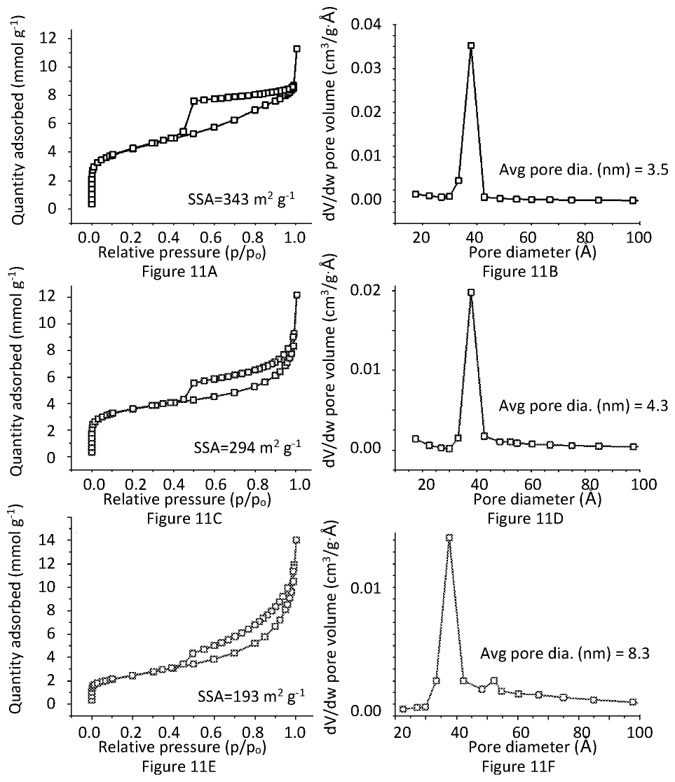

The Fe/N/C-900 catalyst was subjected to additional electrochemical characterization. FIG. 10 shows the comparative ORR LSVs using different Fe concentrations during catalyst synthesis of 2.5, 5 or 7.5 mM Fe³⁺. The LSVs were recorded in O₂ saturated 0.1 M HClO₄ electrolyte with a scan rate of 5 mV s⁻¹ at 1,600 rpm. The onset potentials were found to be 0.73, 0.84 and 0.78 V vs. RHE for the Fe/N/C-900 catalyst synthesized using Fe³⁺ concentrations of 2.5 mM, 5.0 mM, and 7.5 mM, respectively. A control material (N/C) was synthesized without Fe, and was shown to exhibit poor ORR activity with an onset potential of about 0.5 V vs. RHE. The highest onset potential was observed for the catalyst synthesized using Fe/N/C-900 5.0 mM, and this material also exhibited improved limiting current densities compared with the catalysts synthesized using lower or higher Fe concentrations. Without being bound by any theory or mechanism of action, the relatively high performance of this catalyst may be attributed to its specific surface area and pore size (294 m² g⁻¹ and 4.3 nm, FIGS. 11C and 11D, respectively) as compared to the specific surface area and pore size of the catalyst synthesized using Fe/N/C-900 2.5 mM (343 m² g⁻¹ and 3.5 nm, FIGS. 11A and 11B, respectively) and the specific surface area and pore size of the catalyst synthesized using Fe/N/C-900 7.5 mM (193 m² g⁻¹ and 8.3 nm, FIGS. 11E and 11F, respectively). It is contemplated that the specific surface area and pore size of the catalyst synthesized using Fe/N/C-900 5.0 mM enable highly effective di-oxygen transport and product removal from the active sites. It is noted that even the catalyst with the lowest Fe content, Fe/N/C-900 2.5 mM, showed significant ORR activity compared to the control material, which is evidence of a synergistic effect of metallic and N—C catalytic sites for ORR. The catalyst which showed the best ORR performance, namely the one synthesized using Fe/N/C-900 5.0 mM, was chosen for further electrochemical characterization and use in the DFC, and is subsequently referred to as Fe/N/C-900.

### Example 4—Effect of Chloride Ions on the Fe—N—C Catalyst

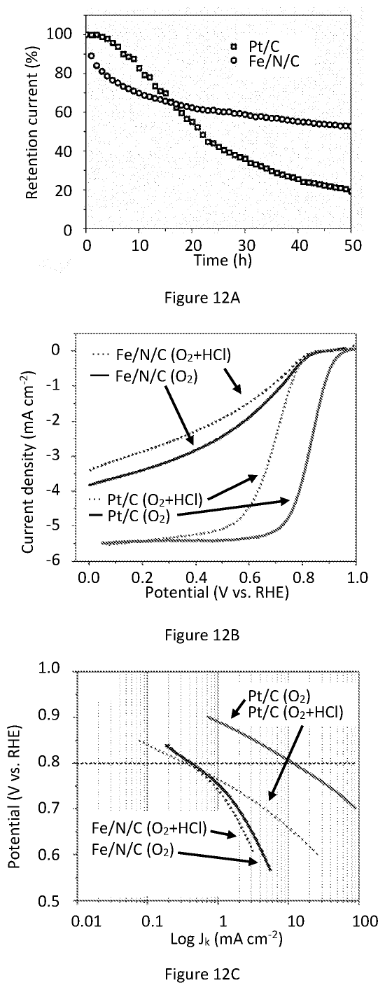

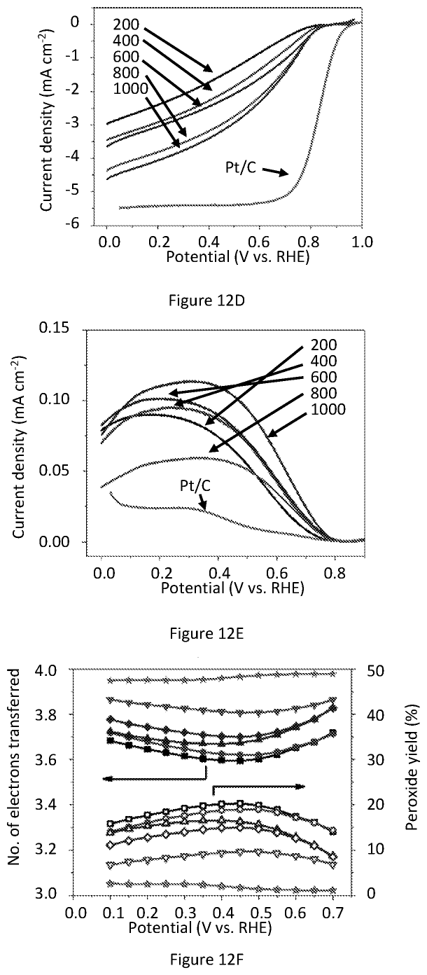

The stability of the Fe/N/C-900 catalyst was determined and compared to that of the Pt/C catalyst using chronoamperometric technique in 0.1 M aqueous HClO₄ electrolyte (FIG. 12A). After 50 h, while the current when using the Fe/N/C-900 catalyst degraded up to 40%, the current when using the Pt/C catalyst degraded by nearly 80%. It is noteworthy that the Pt/C showed excellent stability at the initial 15 h compared to the Fe/N/C catalysts. The initial degradation of Pt/C of up to 80% is in good agreement with the recently reported literature (Q. Wu, Q. Liu, Y. Zhou, Y. Sun, J. Zhao, Y. Liu, F. Liu, M. Nie, F. Ning, N. Yang, X. Jiang, X. Zhou, J. Zhong, Z. Kang, ACS Appl. Mater. Interfaces, 2018, 10(46), 39735; Y. Zhao, J. Wan, H. Yao, L. Zhang, K. Lin, L. Wang, N. Yang, D. Liu, L. Song, J. Zhu, L. Gu, L. Liu, H. Zhao, Y. Li, D. Wang, Nat. Chem. 2018, 10(9), 924; J. Y. Lin, C. Xi, Z. Li, Y. Feng, D. Y. Wu, C. K. Dong, P. Yao, H. Liu, X. W. Du, Chem. Commun. 2019, 55(21), 3121). Nevertheless, after 15 h, the current degraded much faster for the Pt/C as compared to the Fe/N/C. The catalysts were then subjected to a chloride tolerance test (FIG. 12B). The Fe/N/C-900 catalyst exhibited excellent tolerance towards chloride ions during ORR, with only a 10 mV shift in the onset potential. In addition, the limiting current densities recorded with and without Cl⁻ ions were found to be 3.5 and 3.9 mA cm⁻², respectively. When using Pt/C, no significant changes in the limiting current density were found, however, the onset potential substantially decreased to 0.83 V vs. RHE from the initial value of 0.95 V. Without being bound by any theory or mechanism of action, the latter may be attributed to the adsorption of Cl⁻ ions onto the Pt metal sites, which results in corrosion followed by metal dissolution from the carbon support (K. Mamtani, D. Jain, A. C. Co, U. S. Ozkan, Catal. Letters 2017, 147(12), 2903). When using the Fe/N/C catalyst, iron species were largely present in the form of Fe—Nₓ or FeₓC moieties on the support thereby not being prone to adsorption of Cl⁻ ions. The observed minor changes in the ORR activity were likely due to Cl⁻ ions interacting with the non-coordinated iron species, not due to adsorption of Cl⁻ ions onto the coordinated metal centers (U. Tylus, Q. Jia, H. Hafiz, R. J. Allen, B. Barbiellini, A. Bansil, S. Mukerjee, Appl. Catal. B Environ. 2016, 198, 318). Tafel plots were determined from the LSVs with and without Cl⁻ ions for the Fe/N/C-900 and Pt/C catalysts, and are shown in FIG. 12C. The kinetic current densities in the absence of Cl⁻ ions were calculated to be 0.4 and 11.6 mA cm⁻² for Fe/N/C-900 and Pt/C, respectively. However, in Cl⁻ ions environment, the kinetic current density abruptly decreased for Pt/C to 0.3 mA cm⁻², but for the Fe/N/C catalyst no significant degradation was observed (0.38 mA cm⁻²). Mass activities were also affected by Cl⁻ interference and the results are presented in Tables 3A-3B below.

TABLE 3A
Comparative electro-kinetic parameters of Fe/N/C-
900 and Pt/C catalysts with and without Cl⁻ ions.

| | | | | Kinetic | | |
|---|---|---|---|---|---|---|
| | | | | current | Mass | |
| | | Onset | Limiting | density | activity | |
| | | potential | current | (mA/cm²) @ | (MA) (A/g) | Retention |
| | | (V vs. | density | 0.8 V (vs. | @ 0.8 V (vs. | current |
| Catalysts | | RHE) | (mA cm⁻²) | RHE) | RHE) | (%) |
| Fe/N/C- | Without Cl⁻ | 0.85 | 3.9* | 0.416 | 0.70 | 60 |
| 900 | With Cl⁻ | 0.84 | 3.4* | 0.389 | 0.65 | |
| Pt/C | Without Cl⁻ | 0.95 | 5.5 | 11.657 | 0.39^{#} | 10 |
| | With Cl⁻ | 0.84 | 5.5 | 0.346 | 0.01^{#} | |

*@0.1 V
^{#}MA per g of Pt

TABLE 3B
Comparative electro-kinetic parameters of Fe/N/C-
900 and Pt/C catalysts with and without Cl⁻ ions.

| | | Avg. no. | Avg. | | | Mass | |
|---|---|---|---|---|---|---|---|
| | | of | peroxide | | | activity | Catalyst |
| | | electron | yield | ΔEₒₙₛₑₜ | ΔMA | (MA) | loading |
| Catalysts | | transfer | (%) | (mV) | (A mg⁻¹) | (A mg⁻¹) | (μg cm⁻²) |
| Fe/N/C- | Without Cl⁻ | 3.63 | 18.2 | 0 | 0 | 0.001 | 600 |
| 900 | With Cl⁻ | 3.90 | 4.8 | | | 0.001 | |
| Pt/C | Without Cl⁻ | 3.97 | 1.4 | 130 | 0.149 | 0.153 | 75 |
| | With Cl⁻ | 3.88 | 5.6 | | | 0.004 | |

Whereas the ring current was incredibly reduced in the presence of Cl⁻ ions for the Fe/N/C catalyst, the oxidative ring current of the Pt/C catalyst significantly increased. This demonstrates the increased peroxide production that occurs in the Pt/C catalyst in the presence of Cl⁻ ions. While remarkable decrease in the kinetic current and mass activity were identified for the Pt/C catalyst due to Cl⁻ poisoning, the Fe/N/C-900 catalyst showed an excellent ORR kinetics in the presence of unfavorable Cl⁻ ions.

The RRDE measurements were used in order to elucidate the ORR pathway for the Fe/N/C catalyst and recorded in 0.1 M aqueous HClO₄ electrolyte with a scan rate of 5 mV s⁻¹ and a rotational rate of 1,600 rpm. According to previous reports, the reaction pathway extensively depends on the catalyst loading in the RRDE tip (A. Bonakdarpour, M. Lefevre, R. Yang, F. Jaouen, T. Dahn, J. P. Dodelet, J. R. Dahn, Solid-State Lett. 2008, 11(6), B105). Therefore, RRDE measurements were performed with different catalyst loadings of 200, 400, 600, 800 and 1,000 μg cm⁻², and the corresponding disk and ring responses are shown in FIGS. 12D and 12E, respectively. Notably, reduction current decreased when decreasing the catalyst loading on the RRDE tip. Similar onset potentials were observed in LSVs for the catalyst loadings from 1,000 to 400 μg cm⁻², however, further decreasing the loading, onset potential started to decrease substantially (FIG. 12D). Percentage peroxide production and the number of electrons transferred during ORR process were calculated using Equations (8) and (9), respectively, and are shown in FIG. 12F versus potential for various catalyst loadings (□ and ▪ correspond to 200, ∘ and • correspond to 400, Δ and ▴ correspond to 600, ∇ and ▾ correspond to 800, ⋄ and ♦ correspond to 1,000, and ⋆ and ★ correspond to Pt/C). It is to be noted that, Pt/C exhibited a 3.96 electron transfer number, and less than 1.7% peroxide was produced during ORR. For Fe/N/C-900, average peroxide production and the number of electrons transferred during electrochemical reactions were found to be ˜13% and 3.7, respectively, for 600 μg cm⁻² catalysts loading. Increased peroxide reversely correlates with catalyst loading. Without being bound by any theory or mechanism of action, lowering the catalyst loading substantially reduces the catalyst layer thickness, so that produced H₂O₂ during ORR can be readily released from the catalyst layer and be detected by the Pt ring. Higher catalyst loading tends to form a thicker catalyst layer from which the produced H₂O₂ cannot escape as readily, thus reducing the production of H₂O. This increases the measured number of electrons transferred per reduced di-oxygen to approach the more favorable 4e pathway.

Taken together, the RRDE results in FIGS. 12D-12F show that the Fe/N/C-900 catalyst is effective at reducing di-oxygen stepwise via an H₂O₂ byproduct to H₂O. The Fe/N/C-900 catalyst provided the following electrochemical parameters: Electrolyte: acidic; Onset potential (V vs. RHE): 0.85; Limiting current density (mA cm⁻¹): 3.9; Kinetic current density (mA cm⁻¹) @ 0.8 V (vs. RHE): 0.42; Mass activity (A/g) @ 0.8 V (vs. RHE): 0.7.

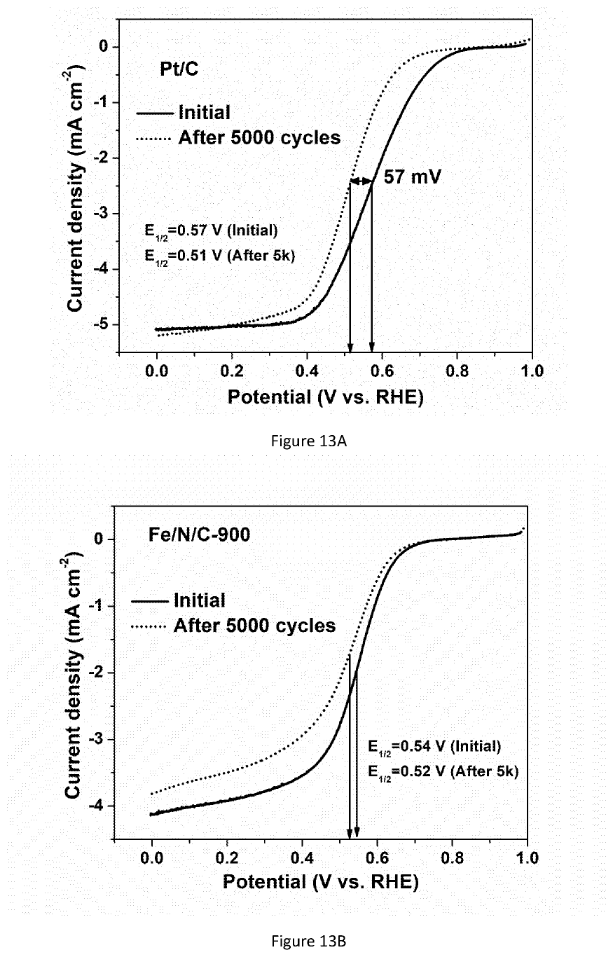

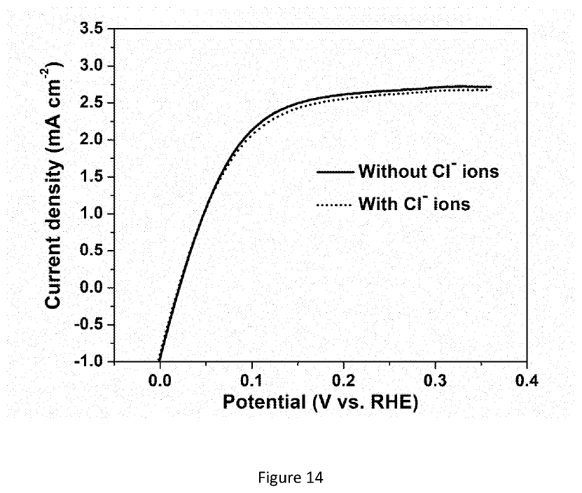

The ORR activities for the Pt/C and Fe/N/C catalysts were investigated in O₂ saturated 0.5 M aqueous NaCl electrolyte (FIGS. 13A-13B). From the LSVs, onset potentials for Pt/C and Fe/N/C were identified at 0.78 and 0.70 V (vs. RHE), respectively. The catalysts were subjected to continuous potential cycles up to 5,000 times in order to examine the extent of durability. After 5,000 cycles, only 10 mV decrease in the onset potential was observed for the Fe/N/C catalyst (FIG. 13B) whereas the Pt/C showed tremendous degradation of nearly 100 mV (FIG. 13A). In terms of half-wave potentials, for Pt/C, nearly 57 mV degradation was observed while the Fe/N/C catalyst was only ˜21 mV. From the aforementioned results, it can be determined that the Fe/N/C catalyst is an effective ORR catalyst in the presence of Cl⁻ ions in HClO₄ and in NaCl electrolyte. The effect of Cl⁻ ions onto the anode electrode was investigated (FIG. 14) and no significant changes in Pt/C HOR activity were noted after adding Cl⁻ ions to the electrolyte. Contrary, Pt surfaces are highly susceptible to halides poisoning at high electrode voltages (>0.8 V, vs. SHE) and the bottleneck of the DFC performance is due to ORR cathode catalysts (A. Pavlišič, P. Jovanovič, V. S. Šelih, M. Šala, N. Hodnik, S. Hočevar, M. Gaberšček, Chem. Commun. 2014, 50, 3732; S. Abdalla, S. Abu Khalla, M. E. Suss, Electrochem. commun. 2021, 132, 107136).

### Example 5—Evaluation of the Fe—N—C Catalyst Efficiency in a DFC

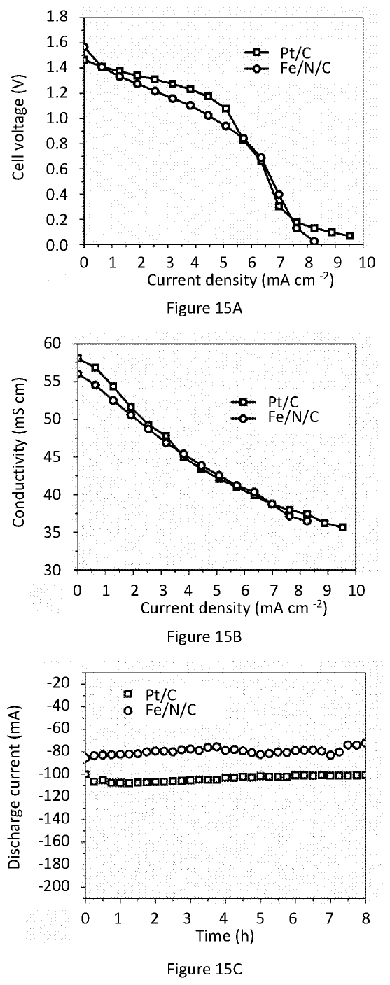

The Fe/N/C catalyst (Fe/N/C-900) was introduced into the DFC cathode. FIG. 15A shows the DFC polarization curve, when operated in 0.5 aqueous NaCl+0.1 M HCl catholyte with the Fe/N/C-900 (2 mg_{catalyst} cm⁻²) or commercial Pt/C (2 mg_{Pt} cm⁻²) cathode catalysts. As seen in the plot, for the cell with the Pt/C cathode catalyst, the measured open circuit voltage (OCV) was 1.46 V, followed by an Ohmic region until a current density of about 5 mA cm⁻², and then mass transport limitations were observed until reaching the limiting current density of 9.5 mA cm⁻². The low OCV, relative to that calculated using the Nernst equation (˜2.06 V), was attributed to chloride poisoning of the Pt, shifting the reaction mechanism to peroxide formation (S. Abdalla, S. Abu Khalla, M. E. Suss, Electrochem. commun. 2021, 132, 107136). The mass transport limitations were attributed to the depletion of H⁺ and OH⁻ from the catholyte and anolyte, respectively (S. Abdalla, S. Abu Khalla, M. E. Suss, Electrochem. commun. 2021, 132, 107136). Activation losses were not observed. When using the Fe/N/C-900 cathode catalyst, a higher OCV of 1.6 V was observed. This observation is in agreement with the RDE and RRDE results, providing further evidence that the Fe/N/C catalyst is less affected by Cl⁻ ions. Activation losses were observed until current density of 0.635 mA/cm² in case of the Fe/N/C catalyst, that are followed by linear Ohmic region up to a current density of 5.7 mA cm⁻², then mass transport limitations were observed until limiting current density of 8.3 mA cm⁻².

In addition to equilibrium cell voltage measurements (FIG. 15A), the equilibrium ionic conductivity of the effluent leaving the desalination channel were also measured. FIG. 15B shows the desalination performance of the cell utilizing both the Pt/C and the Fe/N/C-900 cathodes. It can be seen that the conductivity profile decreased approximately linearly with extracted current density in both cases, showing that the feedwater desalinated concurrently with electricity production (FIG. 15A). The initial conductivity of the effluent leaving the desalination channel in case of utilizing the Pt/C catalyst was 58.12 mS cm, and reached conductivity of 37.47 mS cm at current density of 8.25 mA cm⁻², while at the limiting current it reached conductivity of 35.64 mS cm. In the case of Fe/N/C, the desalination performance was similar to that of the Pt/C, as initial conductivity was 56 mS cm, and it decreased linearly until reaching 36.47 mS cm at a limiting current density of 8.25 mA cm⁻². Comparing cell polarization and desalination results, DFC containing Fe/N/C as the cathode catalyst exhibited a very similar performance to that of commercial Pt/C. Although Pt/C provides better performance in environments free of halide ions (FIG. 12B), in the case of desalination, where chloride ions are inevitably in the anolyte and catholyte, Fe/N/C allows for catalytic performance equal to that of the chloride-poisoned Pt. In order to investigate the stability of the DFCs containing Pt/C and Fe/N/C cathode catalysts, constant voltage of 1 V was applied and the corresponding discharge current was recorded for 8 h. FIG. 15C shows the comparative cell mode stability test of Pt/C and Fe/N/C catalysts. The cell containing the Fe/N/C catalyst exhibited an initial current of ˜85 mA and after 8 h, the current degraded to 72 mA with a rate of 1.6 mA h⁻¹. In case of Pt/C cathodes, current was stable up to 8 h with less degradation (>1 mA h⁻¹). Thus, although the Pt/C degradation rate was higher ex-situ (FIGS. 12A and 13A), it was more stable in situ relative to Fe/N/C. Without being bound by any theory or mechanism of action, this difference may be attributed to mechanical degradation of the Fe/N/C electrode under conditions of flow during cell operation.

Taken together, Fe/N/C catalysts for desalination fuel cell cathodes were synthesized and tested in a desalination fuel cell. Fe/N/C was shown to exert catalytic performance which is at least comparable to that of the Pt/C commercial cathodes in desalination fuel cells. Considering that Fe/N/C is significantly more cost-effective, the data presented herein show that the cost/performance tradeoff strongly favors Fe/N/C over Pt/C for desalination fuel cell applications.

### Example 6—Co/B—C—N Catalysts

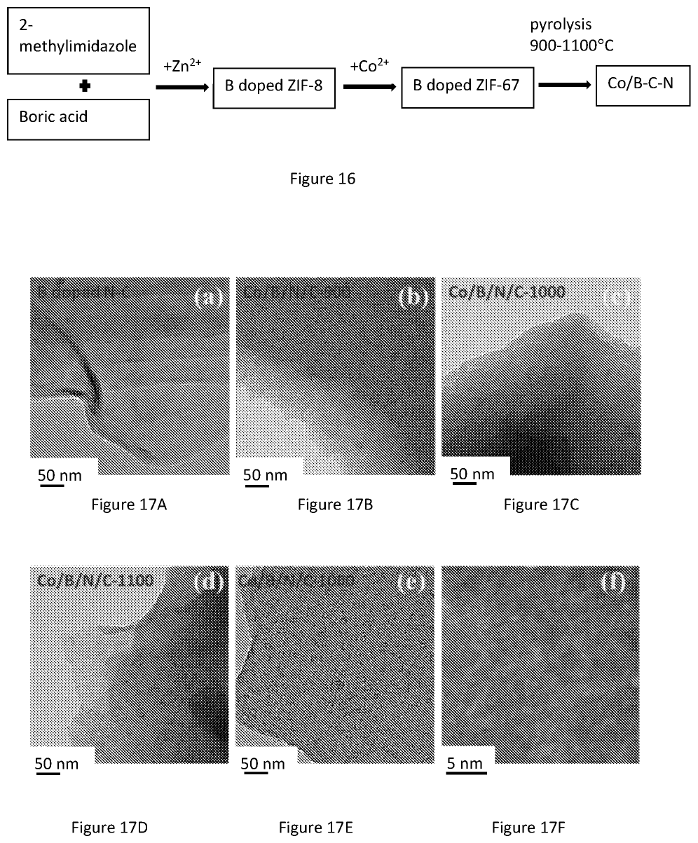

Atomically dispersed Co particles as single atom catalysts (SACs) were prepared. Boron and nitrogen were chosen as the heteroatoms due to their distinct electronegativity behavior. FIG. 16 shows a schematic representation of the synthesis protocol. Typically, 5 g of 2-methylimidazole and 3 g of boric acid were dissolved in 50 mL of anhydrous methanol at room temperature. Then, 0.4 M of zinc nitrate (Zn(NO₃)₂·6H₂O) were added and stirred for 30 min during which a white residue (B-doped ZIF-8) appeared. Subsequently, different concentrations (20, 30 and 40 mM) of methanolic solution of cobalt nitrate (Co(NO₃)₂·6H₂O) were added to the above mixture to obtain purple colored B-doped ZIF-67. The admixture was dried at 60° C. overnight and the residue was collected in a ceramic boat-like crucible for further pyrolysis. Finally, the black product was collected and utilized for physicochemical and electrochemical characterizations.

FIGS. 17A-17D show HR-TEM images of as-synthesized B—C—N and Co/B—C—N catalysts. Thick carbon layers were observed for the metal-free B—N co-doped carbon (B—C—N) material (FIG. 17A). However, after introducing the Co metal into the B—C—N matrix, the thickness of the carbon layers significantly reduced (FIGS. 17B-17E). The HR-TEM images show observable dark spots which are attributed to the metal particles. In order to visualize the particles, HAADF-STEM technique was employed (FIG. 17F) and the bright spots were assigned to the Zn and Co metals which are atomically dispersed onto the carbon framework.

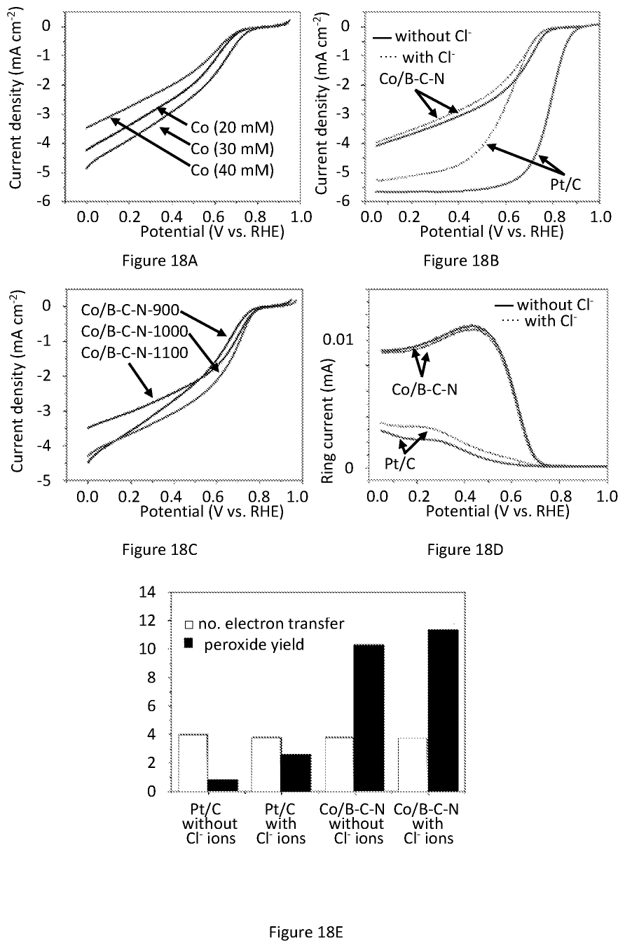

To investigate ORR activities of the synthesized Co/B—C—N catalysts, LSVs were recorded in O₂ saturated 0.1 M aqueous HClO₄ electrolyte with Ag/AgCl and graphite rod as reference and counter electrodes, respectively. FIG. 18A shows the comparative LSVs of the catalysts synthesized with different Co concentrations and pyrolyzed at 900° C. From the LSV, the catalyst obtained from a 30 mM Co precursor showed superior ORR activity with an onset potential of 0.78 V vs. RHE. The B-doped ZIF-67 synthesized using the 30 mM Co precursor was further pyrolyzed at 1,000 and 1,100° C. and the LSVs were compared (FIG. 18C). It is noteworthy that catalysts pyrolyzed at 1,000° C. (Co/B—C—N-1000) and 1,100° C. (Co/B—C—N-1100) showed a similar onset potential of 0.8 V vs. RHE compared with that of the Co/B—C—N-900 catalyst. However, Co/B—C—N-1000 showed the highest limiting current density of ˜4.2 mA cm⁻² and was therefore chosen for subsequent experiments.

A chloride tolerance test was performed using a rotating ring-disk electrode to record the current produced at the Pt ring due to the simultaneous oxidation of hydrogen peroxide formed at the catalyst on the disk electrode. FIGS. 18B and 18D show the disk and ring current, respectively, that were recorded during ORR. The number of electrons transferred (n) and the percentage hydrogen peroxide (% H₂O₂) produced during ORR were calculated by using Equations (8) and (9) and the data are shown in FIG. 18E. Interestingly, in the presence of Cl⁻ ions, the n and % H₂O₂ values for Pt/C significantly changed resulting in decreased ORR activity attributed to Pt surface poisoning. In contrast, Co/B—C—N-1000 showed almost similar performance before and after HCl addition demonstrating a chloride-tolerant behavior.

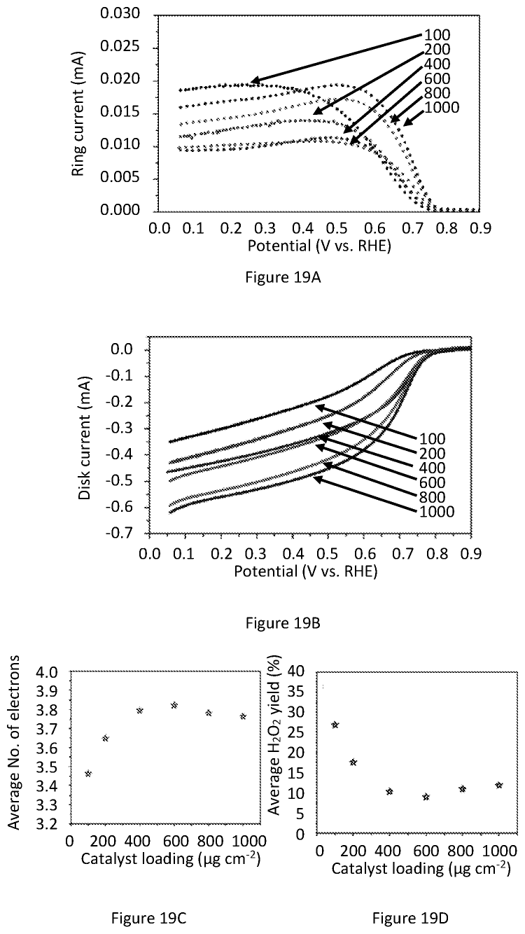

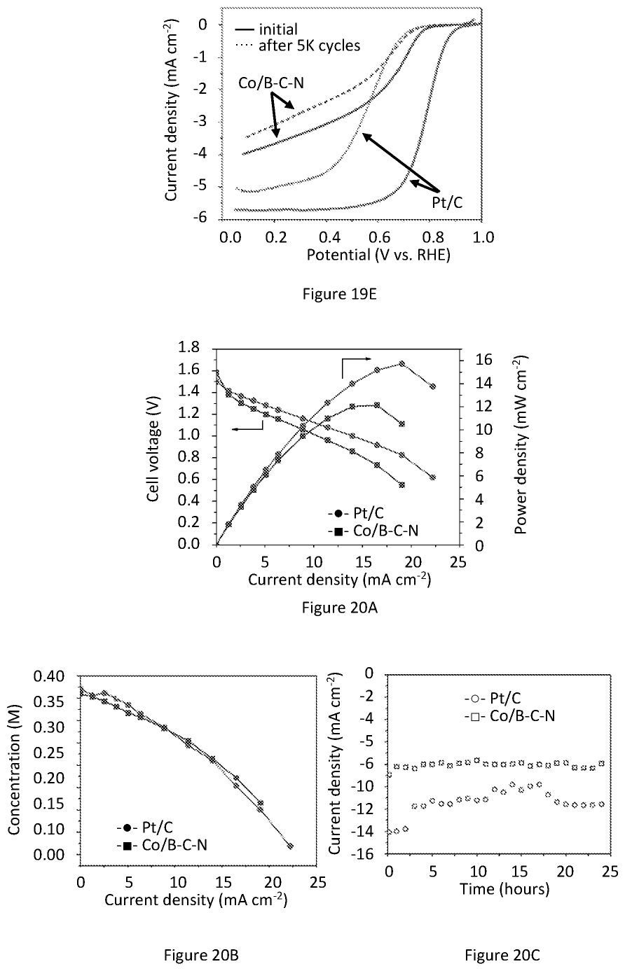

RRDE was evaluated for different catalyst loading using LSVs. The results of the ring and disk currents are shown in FIGS. 19A and 19B, respectively. The average number of electrons transferred and hydrogen peroxide yield during ORR was calculated for the different loadings (FIGS. 19C and 19D, respectively). It can be observed that the lowest loading i.e., 100 μg cm⁻², exhibited n=3.4 and % H₂O₂=26% during ORR. Despite the formation of peroxide, the average electron transfer number was maintained above 3. Without being bound by any theory or mechanism of action, it is contemplated that with catalyst loading of less than 100 μg cm⁻², two step ORR pathway occurs whereby the higher hydrogen peroxide production limits the ORR production of H₂O as the final product. Nonetheless, at catalyst loading higher than 100 μg cm⁻², O₂ to H₂O production can be performed at the direct pathway.

To investigate the durability of the catalyst, continuous potential cycles method was adopted and the CVs were repeated 5,000 times and the LSVs were compared before and after multiple cycles (FIG. 19E). It can be seen that Pt/C underwent severe deterioration with potential cycles, and exhibited an onset potential of 0.73 V (vs. RHE) after 5,000 cycles while its initial onset potential was 0.92 V. This is attributed to Pt particle dissolution and redeposition onto the catalyst support, resulting in Pt particles' agglomeration. In contrast, the Co/B—C—N-1000 catalyst showed an onset potential of 0.80 and 0.76 V (vs. RHE) before and after 5,000 potential cycles, respectively, showing significant catalyst durability.

Finally, the Co/B—C—N-1000 catalyst was utilized in DFC cathode electrode with a loading of 2 mg cm⁻² and the cell polarization and desalination performance were recorded and compared to those of the state-of-the-art Pt/C catalyst (FIGS. 20A-20B). The open circuit voltage (OCV) for the cell containing the Pt/C cathode was 1.49 V with a peak power density of 15.7 mW cm⁻² at a load current density of 19.0 mA cm⁻²(FIG. 20A). The DFC with the Co/B—C—N-1000 cathode showed the highest OCV (1.58 V). In addition, the cell delivered a peak power density of 12.1 mW cm⁻² at a load current density of 16.5 mA cm⁻². The initial concentration of the feedwater during OCV was recorded to be 0.37 and 0.36 M for the Pt/C and Co/B—C—N-1000 catalysts, respectively (FIG. 20B). The decrease in the feedwater concentration is indicative of the extent of the desalination process. For the Co/B—C—N-1000 catalyst, the feedwater concentration gradually decreased up to 0.28 M at a load current density of 8.8 mA cm⁻² showing a better desalination process compared to that of the Pt/C cathode. At higher current density, the feedwater concentration was similar for both the Pt/C and Co/B—C—N-1000 catalysts. FIG. 20C shows the stability of DFCs with Pt/C and Co/B—C—N-1000 catalysts. Co/B—C—N-1000 cathode showed a stable current density of about 8.5 mA cm⁻² up to 24 h, whereas Pt/C showed significantly reduced current density from the initial 14 mA cm⁻² to 12 cm⁻² after 24 h.

Taken together, the results show that Co/B—C—N catalysts according to certain embodiments of the present invention provide excellent DFC performance and thus can be used as an alternative to the Pt-based catalysts which further suffer from halide poisoning.

It is appreciated by persons skilled in the art that the present invention is not limited by what has been particularly shown and described hereinabove. Rather the scope of the present invention includes both combinations and sub-combinations of various features described hereinabove as well as variations and modifications. Therefore, the invention is not to be constructed as restricted to the particularly described embodiments, and the scope and concept of the invention will be more readily understood by references to the claims, which follow.

1-34. (canceled)

35. A deionization fuel cell (DFC) comprising:
a cathode; an anode; a catholyte flow channel; an anolyte flow channel, and at least:
a cation exchange membrane (CEM); an anion exchange membrane (AEM), and a feedwater flow channel, wherein:
the catholyte flow channel is disposed adjacent to the cathode, the anolyte flow channel is disposed adjacent to the anode, and the feedwater flow channel is formed between the CEM and the AEM and is configured for the deionization of feedwater;
wherein the feedwater contains at least 10 mM of chloride ions (Cl⁻);
wherein the cathode comprises a catalyst comprising a non-platinum group metal and a nitrogen doped carbon matrix;
wherein the catalyst is configured to catalyze an oxygen reduction reaction (ORR) taking place at the cathode; and
wherein the DFC is a non-biological DFC.

36. The DFC of claim 35, wherein the non-platinum group metal is a non-platinum group transition metal.

37. The DFC of claim 36, wherein the non-platinum group transition metal comprises at least one of Fe, Co, Mn, Zn, Ce, Cr, Cu, Mo, Ni, Ta, Ti, V, W, and Zr.

38. The DFC of claim 37, wherein the non-platinum group transition metal is iron (Fe).

39. The DFC of claim 38, wherein the catalyst comprises metal nanoparticles having a mean particle size of above 8 nm, or wherein the catalyst comprises metal nanoparticles having a mean particle size of about 10 nm to about 40 nm.

40. The DFC of claim 37, wherein the non-platinum group transition metal is cobalt (Co).

41. The DFC of claim 40, wherein the catalyst comprises metal particles which are atomically dispersed in the carbon matrix.

42. The DFC of claim 35, wherein the carbon matrix comprises a graphitic carbon lattice.

43. The DFC of claim 42, wherein the graphitic carbon lattice is characterized by a degree of disorder ranging from 0.8 to 1.11.

44. The DFC of claim 35, wherein the catalyst has a mean pore size of about 3 nm to about 10 nm; or wherein the catalyst comprises a nitrogen content of less than about 2% at.

45. The DFC of claim 35, wherein the carbon is further doped by boron, wherein the catalyst comprises a boron content ranging between about 0.01% at. and about 1% at.

46. The DFC of claim 35, wherein the feedwater contains at least about 20 mM of chloride ions (Cl⁻); or wherein the feedwater is selected from the group consisting of: seawater, brackish water, hard water, wastewater and organic streams needing remediation.

47. The DFC of claim 35, wherein the CEM and/or AEM is independently at each occurrence, selected from the group consisting of: an ion-selective polymeric membrane, an ion-selective ceramic separator, an ion-selective zeolite separator, and an ion-selective glass separator.

48. The DFC of claim 47, wherein the AEM is selected from the group consisting of: non-alkaline anion exchange membrane, alkaline anion exchange membrane (AAEM), hydroxide-exchange membrane (HEM), anion-exchange ionomer membrane (AEI), and combinations thereof, or wherein the CEM is selected from the group consisting of: non-acidic cation exchange membrane, proton-exchange membrane (PEM), cation-exchange ionomer membrane, and combinations thereof.

49. The DFC of claim 35, wherein the anolyte flow channel comprises a reductant and/or its oxidation reaction product, wherein the reductant comprises hydrogen gas (H₂); or wherein the catholyte flow channel comprises an oxidant and/or its reduction reaction product, wherein the oxidant comprises oxygen gas (O₂).

50. A method of preparing a chloride-tolerant catalyst comprising a non-platinum group metal and a nitrogen doped carbon matrix, the method comprising:
(a) providing a precursor comprising a zeolitic imidazolate framework (ZIF) and non-platinum group metal ions; and
(b) pyrolyzing the precursor of step (a) at a temperature ranging from above 800° C. to below 1,100° C.

51. The method of claim 50, wherein the ZIF is a B doped ZIF.

52. A chloride-tolerant Fe—N—C catalyst prepared according to the method of claim 50.

53. A chloride-tolerant Co—B—C—N catalyst prepared according to the method of claim 51.

54. A deionization fuel cell comprising:
a cathode; an anode; a catholyte flow channel; an anolyte flow channel, and at least:
a cation exchange membrane (CEM); an anion exchange membrane (AEM), and a feedwater flow channel, wherein:
the catholyte flow channel is disposed adjacent to the cathode, the anolyte flow channel is disposed adjacent to the anode, and the feedwater flow channel is formed between the CEM and the AEM and is configured for the deionization of feedwater;
wherein the cathode comprises a chloride-tolerant catalyst comprising a non-platinum group metal and a nitrogen doped carbon matrix prepared according to the method of claim 50.
